(19) United States
(12) Patent Application Publication
(10) Pub. No.: US 2026/0252235 A1
(43) Pub. Date: Aug. 27, 2026

(54) PRINTING DEVICE AND OPERATION UNIT

(71) Applicant: SEIKO EPSON CORPORATION, Tokyo (JP)

(72) Inventor: Yusuke YAMASHITA, MATSUMOTO-SHI (JP)

(21) Appl. No.: 19/548,194

(22) Filed: Feb. 24, 2026

(30) Foreign Application Priority Data
Feb. 27, 2025 (JP) 2025-029868

(51) Int. Cl. G06F 3/04886; B41J 3/46; B41J 29/00; G06F 3/044

(52) U.S. Cl. CPC G06F 3/04886; B41J 3/46; B41J 29/00; G06F 3/044

(57) ABSTRACT

A printing device includes a power switch that receives state change of a power supply and an operation unit that receives an input operation by a user, wherein the operation unit includes a display panel that displays a plurality of touch keys that receive touch input by the user and a soft key that receives the touch input by the user and the soft key is provided on an outer peripheral section of the display panel.

The present application is based on, and claims priority from JP Application Serial Number 2025-029868, filed February 27, 2025, the disclosure of which is hereby incorporated by reference herein in its entirety.

### BACKGROUND

### 1. Technical Field

The present disclosure relates to a printing device and an operation unit.

### 2. Related Art

A printing device including a touch panel is known. The printing device described in JP-A-2023-9871 includes a capacitive touch panel and a power operation section. The capacitive touch panel displays a basic screen including soft keys. The power operation section includes a mechanical key that switches a power state of the printing device.

The printing device described in JP-A-2023-9871 does not include a touch input button that is arranged at a position different from a position where the screen is displayed. There is room for improvement in the arrangement of the touch input button.

### SUMMARY

A printing device of the present disclosure includes a power switch that receives state change of a power supply and an operation unit that receives an input operation by a user, wherein the operation unit includes a display panel that displays a plurality of touch keys that receive touch input by the user and a soft key that receives the touch input by the user and the soft key is provided on an outer peripheral section of the display panel.

An operation unit of the present disclosure includes a display panel that displays a plurality of touch keys that receive touch input by a user and a soft key that is provided on an outer peripheral section of the display panel and that receives the touch input by a user.

### BRIEF DESCRIPTION OF THE DRAWINGS

FIG. 1 is a diagram illustrating an external configuration of a printer.

FIG. 2 is a diagram illustrating a schematic configuration of the printer.

FIG. 3 is a diagram illustrating a block configuration of the printer.

FIG. 4 is a diagram illustrating an example of a schematic configuration of a touch input key.

FIG. 5 is a diagram illustrating a schematic configuration of a control panel.

FIG. 6 is a diagram illustrating a schematic configuration of the control panel.

FIG. 7 is a diagram illustrating a schematic configuration of the control panel.

FIG. 8 is a diagram illustrating a schematic configuration of the control panel.

FIG. 9 is a diagram illustrating a schematic configuration of the control panel.

FIG. 10 is a diagram illustrating a schematic configuration of the control panel.

FIG. 11 is a diagram illustrating a schematic configuration of the control panel.

FIG. 12 is a diagram illustrating a schematic configuration of the control panel.

FIG. 13 is a diagram illustrating a schematic configuration of the control panel.

FIG. 14 is a diagram illustrating a schematic configuration of the control panel.

FIG. 15 is a diagram illustrating a schematic configuration of the control panel.

### DESCRIPTION OF EMBODIMENTS

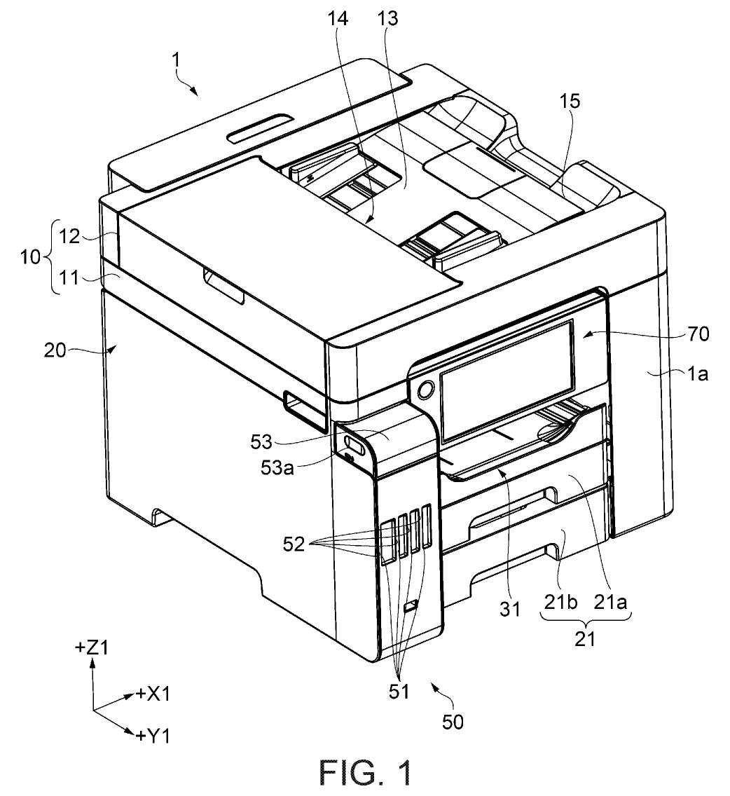

FIG. 1 illustrates an external configuration of a printer 1. FIG. 1 is a perspective view illustrating an external appearance of the printer 1. The printer 1 corresponds to an example of a printing device. The printer 1 has a reading function of reading a document and a printing function of performing printing on a paper sheet S. The printer 1 may also have a fax function of sending and receiving faxes. The printer 1 includes a scanner unit 10, a printer unit 20, an ink tank unit 50, and a control panel 70.

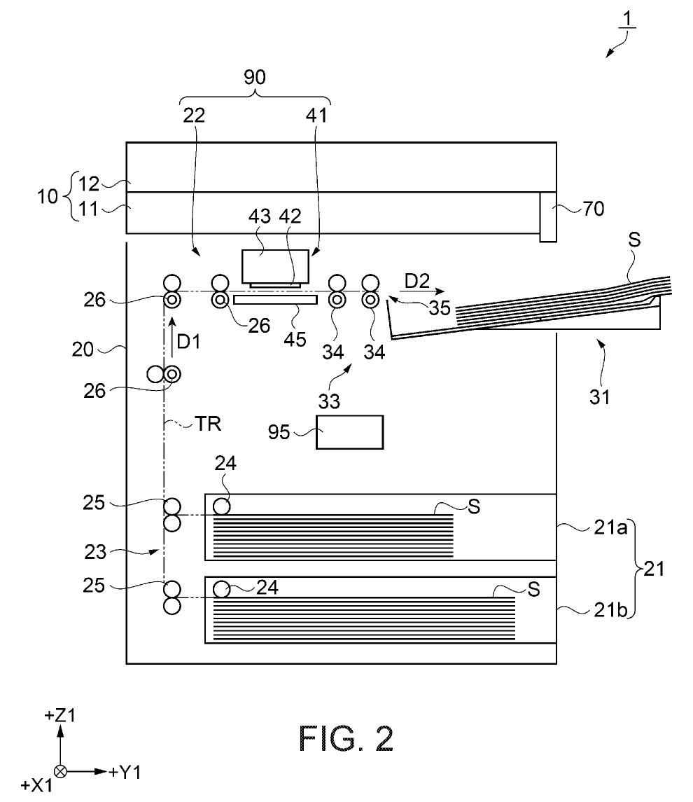

FIGS. 1 and 2 illustrate a coordinate system including an X1-axis, a Y1-axis, and a Z1-axis. The Z1-axis is an axis orthogonal to an installation surface of the printer 1. A +Z1 direction is a direction from the installation surface toward an upper side. A - Z1 direction is a direction from above toward the installation surface. The X1-axis is an axis orthogonal to the Z1-axis. A +X1 direction is a direction from left to right in plan view of a front surface 1a of the printer 1. The front surface 1a of the printer 1 is a surface on which the control panel 70 is provided. A -X1 direction is a direction from right to left in plan view of the front surface 1a of the printer 1. The Y1-axis is an axis orthogonal to the X1-axis and the Z1-axis. A +Y1 direction is a direction from a rear side of the printer 1 toward the front surface 1a. A -Y1 direction is a direction from the front surface 1a of the printer 1 toward the rear side.

The scanner unit 10 includes a document placement section support housing 11 and an ADF support housing 12. ADF is an abbreviation for automatic document feeder. The scanner unit 10 accommodates a reading mechanism 80 (to be described later).

The document placement section support housing 11 supports a document placement section (not illustrated). The document placement section support housing 11 accommodates a part of the reading mechanism 80. The document placement section support housing 11 pivotably supports the ADF support housing 12. The document placement section support housing 11 is arranged at a position in the +Z1 direction of the printer unit 20.

The ADF support housing 12 has a function of transporting a document. The ADF support housing 12 accommodates a part of the reading mechanism 80. The ADF support housing 12 is configured to be pivotable about a pivot axis parallel or substantially parallel to the X1-axis with respect to the document placement section support housing 11. The ADF support housing 12 is arranged at a position in the +Z1 direction of the document placement section support housing 11. The ADF support housing 12 includes a document placement tray 13, a document supply port 14, a document transport mechanism (not illustrated), and a document discharge tray 15.

The document placement tray 13 places one or more documents thereon. The document placement tray 13 is provided on a surface of the ADF support housing 12 in the +Z1 direction. A document placed on the document placement tray 13 is transported by the document transport mechanism.

The document supply port 14 supplies a document placed on the document placement tray 13 to the inside of the ADF support housing 12. The document supply port 14 is provided at a position in the -X1 direction of the document placement tray 13. A document supplied from the document supply port 14 to the inside of the ADF support housing 12 is transported by the document transport mechanism.

The document transport mechanism is provided inside the ADF support housing 12. The document transport mechanism transports a document supplied from the document supply port 14 toward the document discharge tray 15. The document transport mechanism transports a document toward a reading sensor (not illustrated) and causes the reading sensor to read the document.

The document discharge tray 15 places a document transported by the document transport mechanism. The document discharge tray 15 places a document read by the reading sensor. The document discharge tray 15 is provided at a position in the -Z1 direction of the document placement tray 13.

The printer unit 20 performs printing on the paper sheet S. The printer unit 20 accommodates a printing mechanism 90 (to be described later). The printer unit 20 is arranged at a position in the -Z1 direction of the scanner unit 10. The printer unit 20 includes a paper sheet accommodation section 21 and a paper sheet discharge placement section 31.

The paper sheet accommodation section 21 accommodates the paper sheet S to be printed by the printing mechanism 90. The paper sheet accommodation section 21 is provided on the front surface 1a of the printer 1. The paper sheet accommodation section 21 illustrated in FIG. 1 includes a first paper sheet feeding cassette 21a and a second paper sheet feeding cassette 21b.

The first paper sheet feeding cassette 21a accommodates one or more paper sheets S. The first paper sheet feeding cassette 21a is arranged at a position in the +Z1 direction of the second paper sheet feeding cassette 21b. The first paper sheet feeding cassette 21a is provided so as to be insertable into and removable from the printer unit 20 in parallel or substantially in parallel to the Y1-axis.

The second paper sheet feeding cassette 21b accommodates one or more paper sheets S. The second paper sheet feeding cassette 21b is arranged at a position in the -Z1 direction of the printer unit 20. The second paper sheet feeding cassette 21b is provided so as to be insertable into and removable from the printer unit 20 in parallel or substantially in parallel to the Y1-axis. The second paper sheet feeding cassette 21b accommodates the paper sheet S of the same size as or a different size from the paper sheet S accommodated in the first paper sheet feeding cassette 21a.

The paper sheet accommodation section 21 illustrated in FIG. 1 includes the first paper sheet feeding cassette 21a and the second paper sheet feeding cassette 21b, but the paper sheet accommodation section 21 is not limited to this. One or more paper sheet feeding cassettes are provided in the printer unit 20.

The paper sheet discharge placement section 31 places the paper sheet S printed by the printing mechanism 90. The paper sheet discharge placement section 31 is provided on the front surface 1a of the printer 1. The paper sheet discharge placement section 31 is configured by a paper sheet discharge tray, for example. The paper sheet discharge tray is arranged at a position in the +Z1 direction of the first paper sheet feeding cassette 21a. The paper sheet discharge tray may include a support member that supports the paper sheet S. The support member is configured to be extendable in the +Y1 direction with respect to the paper sheet discharge tray, for example.

The ink tank unit 50 accommodates one or more ink tanks 51 that supply ink to the printing section 41 (to be described later). The ink tank unit 50 is provided at a position in the -X1 direction of the paper sheet accommodation section 21 and the paper sheet discharge placement section 31. The ink tank unit 50 includes one or more ink tanks 51, viewing windows 52, and an ink tank cover 53.

The ink tank 51 is a container that accommodates ink. The ink tank unit 50 illustrated in FIG. 1 includes the plurality of ink tanks 51. The plurality of ink tanks 51 respectively accommodate different ink. The plurality of ink tanks 51 may accommodate the same ink. A surface of the ink tank 51 in the +Y1 direction is configured so that ink accommodated therein can be visually recognized.

The viewing window 52 is configured to allow an amount of ink accommodated in the ink tank 51 to be visually recognized. The viewing window 52 is provided on a surface of the ink tank unit 50 in the +Y1 direction. A user visually recognizes an amount of ink accommodated in the ink tank 51 through the viewing window 52.

The ink tank cover 53 covers the ink tank 51 accommodated in the ink tank unit 50 at a position in the +Z1 direction. The ink tank cover 53 is configured to be able to open and close the inside of the ink tank unit 50. The ink tank cover 53 is provided with a handle 53a.

The handle 53a is used when a user opens and closes the ink tank cover 53. The user opens and closes the ink tank cover 53 using the handle 53a. The ink tank cover 53 moves to a closed position where the inside of the ink tank unit 50 is covered and an opened position where the inside of the ink tank unit 50 is opened. When the ink tank cover 53 is moved to the opened position, the user can refill the ink tank 51 with ink.

The control panel 70 receives an input operation by a user. The control panel 70 corresponds to an example of an operation unit. The control panel 70 is provided on the front surface 1a of the printer 1. The control panel 70 will be described in detail later.

FIG. 2 illustrates a schematic configuration of the printer 1. FIG. 2 illustrates a Y1-Z1 cross section of the printer 1. FIG. 2 illustrates an internal configuration of the printer unit 20. The printer unit 20 accommodates the printing mechanism 90 and a power supply unit 95.

The printing mechanism 90 performs printing on the paper sheet S. The printing mechanism 90 transports the paper sheet S to a predetermined position. The printing mechanism 90 performs printing on the paper sheet S transported to a predetermined position. The printing mechanism 90 includes a paper sheet transport section 22 and the printing section 41.

The paper sheet transport section 22 transports the paper sheet S from the paper sheet accommodation section 21 toward the paper sheet discharge placement section 31. The paper sheet transport section 22 transports the paper sheet S along a paper sheet transport path TR. The paper sheet transport section 22 includes a feeding section 23 and a discharge section 33.

The feeding section 23 transports the paper sheet S accommodated in the paper sheet accommodation section 21 toward the printing section 41. The feeding section 23 transports the paper sheet S along a transport direction D1. The feeding section 23 includes pickup rollers 24, separation roller pairs 25, and transport roller pairs 26.

The pickup roller 24 sends out the paper sheet S accommodated in the first paper sheet feeding cassette 21a or the second paper sheet feeding cassette 21b to the paper sheet transport path TR. Each of the plurality of paper sheet feeding cassettes is provided with the pickup roller 24. The feeding section 23 illustrated in FIG. 2 includes two pickup rollers 24. The two pickup rollers 24 respectively send out the paper sheet S accommodated in the first paper sheet feeding cassette 21a and the paper sheet S accommodated in the second paper sheet feeding cassette 21b toward the paper sheet transport path TR. The pickup roller 24 is rotationally driven by a drive force of a drive source (not illustrated). The pickup roller 24 is driven to rotate to send out the paper sheet S to the paper sheet transport path TR.

The separation roller pair 25 separates the paper sheet S sent out by the pickup roller 24 into one paper sheet S. When the pickup roller 24 sends out a plurality of paper sheets S to the paper sheet transport path TR, the separation roller pair 25 separates one paper sheet S from the plurality of paper sheets S and sends out the one paper sheet S to the paper sheet transport path TR. The separation roller pair 25 is arranged for each of the plurality of pickup rollers 24. The feeding section 23 illustrated in FIG. 2 includes two separation roller pairs 25. The two separation roller pairs 25 are arranged for the two pickup rollers 24, respectively. The separation roller pair 25 is rotationally driven by a drive force of a drive source. The separation roller pair 25 is driven to rotate to send out one paper sheet S to the paper sheet transport path TR.

The transport roller pairs 26 transport the paper sheet S in the paper sheet transport path TR toward the printing section 41. The transport roller pairs 26 are arranged along the paper sheet transport path TR. The feeding section 23 illustrated in FIG. 2 includes three transport roller pairs 26, but the number of the transport roller pairs 26 is not limited thereto. The number of the transport roller pairs 26 is set as appropriate. The transport roller pair 26 is rotationally driven by a drive force of a drive source. The transport roller pair 26 is driven to rotate to transport the paper sheet S.

The discharge section 33 transports the paper sheet S printed by the printing section 41 toward the paper sheet discharge placement section 31. The discharge section 33 discharges the paper sheet S in a discharge direction D2. The discharge section 33 includes discharge roller pairs 34 and a discharge port 35.

The discharge roller pairs 34 transport the paper sheet S printed by the printing section 41 toward the paper sheet discharge placement section 31. The discharge roller pairs 34 are arranged along the paper sheet transport path TR. The discharge section 33 illustrated in FIG. 2 includes two discharge roller pairs 34, but the present disclosure is not limited thereto. The number of the discharge roller pairs 34 is set as appropriate. The discharge roller pair 34 is rotationally driven by a drive force of a drive source. The discharge roller pair 34 is driven to rotate to transport the paper sheet S.

The discharge port 35 is an opening through which the paper sheet S is discharged from the inside of the printer unit 20. The discharge port 35 discharges the paper sheet S transported by the discharge roller pairs 34 to the paper sheet discharge placement section 31. The paper sheet S discharged from the discharge port 35 is placed on the paper sheet discharge placement section 31.

The drive source that rotationally drives the pickup roller 24, the separation roller pair 25, the transport roller pair 26, and the discharge roller pair 34 may be configured by one motor or may be configured by a plurality of motors. A configuration of the drive source is set as appropriate.

The printing section 41 performs printing on the paper sheet S. The printing section 41 performs printing by ejecting ink onto the paper sheet S, for example. The printing section 41 may be an inkjet type that ejects ink onto the paper sheet S, or may be an electrophotographic type. The printing section 41 illustrated in FIG. 2 is an inkjet type. The printing section 41 includes a print head 42 and a carriage 43.

The print head 42 ejects ink toward the paper sheet S. The print head 42 prints an image on the paper sheet S by ejecting ink toward the paper sheet S. The print head 42 includes a plurality of nozzles on a surface facing the paper sheet S. Ink is ejected from the plurality of nozzles. The print head 42 ejects ink of one or a plurality of colors onto the paper sheet S.

The carriage 43 movably supports the print head 42. The carriage 43 moves the print head 42 in the +X1 direction or the -X1 direction along the X1-axis. The print head 42 ejects ink onto the paper sheet S while moving along the X1-axis.

A platen 45 is arranged at a position facing the plurality of nozzles of the print head 42. The platen 45 supports the paper sheet S transported by the transport roller pairs 26. The platen 45 supports the paper sheet S at a predetermined interval with respect to the print head 42. The platen 45 supports the paper sheet S onto which ink is ejected by the print head 42.

The power supply unit 95 is supplied with power from an external power supply. The power supply unit 95 supplies power to the scanner unit 10, the printer unit 20, and the like. The power supply unit 95 corresponds to an example of a power supply. The power supply unit 95 changes its state based on an instruction from a user. The power supply unit 95 is turned on or off based on an instruction from the user. The power supply unit 95 changes to an operable state or an energy saving state based on an instruction from the user. The energy saving state is a state in which power consumption is less than that in the operable state. The power supply unit 95 changes its state from on to off or from off to on. The power supply unit 95 changes its state from the operable state to the energy saving state or from the energy saving state to the operable state.

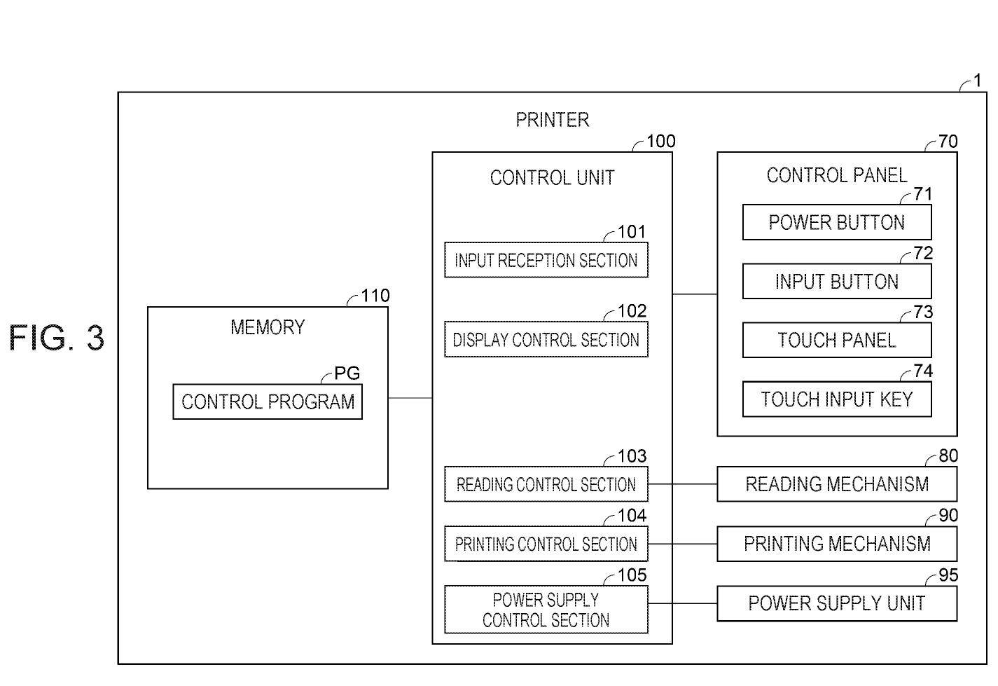

FIG. 3 illustrates a block configuration of the printer 1. The printer 1 includes the control panel 70, the reading mechanism 80, the printing mechanism 90, the power supply unit 95, a control unit 100, and a memory 110.

The control panel 70 transmits various input data to the control unit 100. The control panel 70 displays various screens based on the control of the control unit 100. The control panel 70 includes a power button 71, an input button 72, a touch panel 73, and a touch input key 74. The control panel 70 may include an indicator lamp 75 and the like. The control panel 70 is configured to be pivotable about a pivot axis parallel or substantially parallel to the X1-axis. In the present embodiment, a configuration in which the control panel 70 includes the power button 71 is illustrated, but the configuration of the control panel 70 is not limited thereto. A configuration in which the control panel 70 does not include the power button 71 may be adopted. In other words, a configuration in which the power button 71 is separated from the control panel 70 may be adopted.

The power button 71 receives an input operation by a user. The power button 71 corresponds to an example of a power switch. The power button 71 receives, as input operations, a power supply input instruction operation and a power supply disconnection instruction operation for instructing state change of the power supply unit 95. The power supply input instruction operation is an instruction to change the state of the power supply unit 95 to on. The power supply disconnection instruction operation is an instruction to change the state of the power supply unit 95 to off. The power button 71 receives state change of the power supply unit 95 by an input operation by a user.

The power button 71 may be configured by a mechanical mechanism that mechanically switches an electrical signal, or may be configured by a mechanism such as a resistive film analog type, a capacitance type, an optical type, or an infrared type. The power button 71 is desirably configured by the mechanical mechanism. The power button 71 is configured by the mechanical mechanism, and thus, the reliability of operation, the durability of the power button 71, and the like are improved.

When the power button 71 receives an input operation by a user, the power button 71 generates a control signal and transmits the control signal to the control unit 100. For example, when the power button 71 receives the power supply input instruction operation, the power button 71 transmits a power supply input instruction signal to the control unit 100. When the power button 71 receives the power supply disconnection instruction operation, the power button 71 transmits a power supply disconnection instruction signal to the control unit 100. The power supply input instruction signal and the power supply disconnection instruction signal are examples of the control signal. The power button 71 switches the power supply unit 95 on and off by transmitting the power supply input instruction signal and the power supply disconnection instruction signal to the power supply unit 95. The power button 71 has a power on and off function of switching the power supply unit 95 on and off. The power on and off function corresponds to an example of an on and off switching function.

The power button 71 may receive a sleep activation instruction operation and a sleep stop instruction operation as input operations. The sleep activation instruction operation is an input operation for instructing activation of a sleep mode for reducing power consumption of the printer 1. The sleep stop instruction operation is an input operation for instructing the stop of the sleep mode.

When the power button 71 receives the sleep activation instruction operation, the power button 71 transmits a power-saving start instruction signal to the control unit 100. When the power button 71 receives the sleep stop instruction operation, the power button 71 transmits a power-saving stop instruction signal to the control unit 100. The power-saving start instruction signal and the power-saving stop instruction signal are examples of the control signal. The power button 71 switches a power saving function of the power supply unit 95 between activation and stop by transmitting the power-saving start instruction signal and a power-saving stop instruction signal to the power supply unit 95. The power button 71 has a sleep mode switching function of switching the power saving function of the power supply unit 95 between activation and stop. The sleep mode switching function corresponds to an example of a power-saving switching function.

The power button 71 is desirably mechanical and has the power on and off function of switching the power supply unit 95 on and off and a sleep mode switching function of switching the power saving function between activation and stop.

The power button 71 is mechanically configured, and thus it is possible to reliably execute state change of the power supply unit 95. The power button 71 has the sleep mode switching function, and thus a configuration of the control panel 70 is simplified.

The input button 72 receives an input operation by a user. The input button 72 is formed of, for example, a component that mechanically switches an electrical signal. The input button 72 includes a plurality of number input buttons 72a (to be described later) and the like. When a user performs an input operation on the input button 72, various control signals are generated. The various control signals are transmitted to the control unit 100.

The touch panel 73 is a display having an input function. The touch panel 73 has a display function and a touch input function. The touch panel 73 includes a liquid crystal display, an organic electro-luminescence (EL) display, or the like. The touch panel 73 corresponds to an example of a display panel. The touch input function of the touch panel 73 is configured by a mechanism of a resistive film analog type, a projected capacitance type, an optical type, an infrared type, or the like.

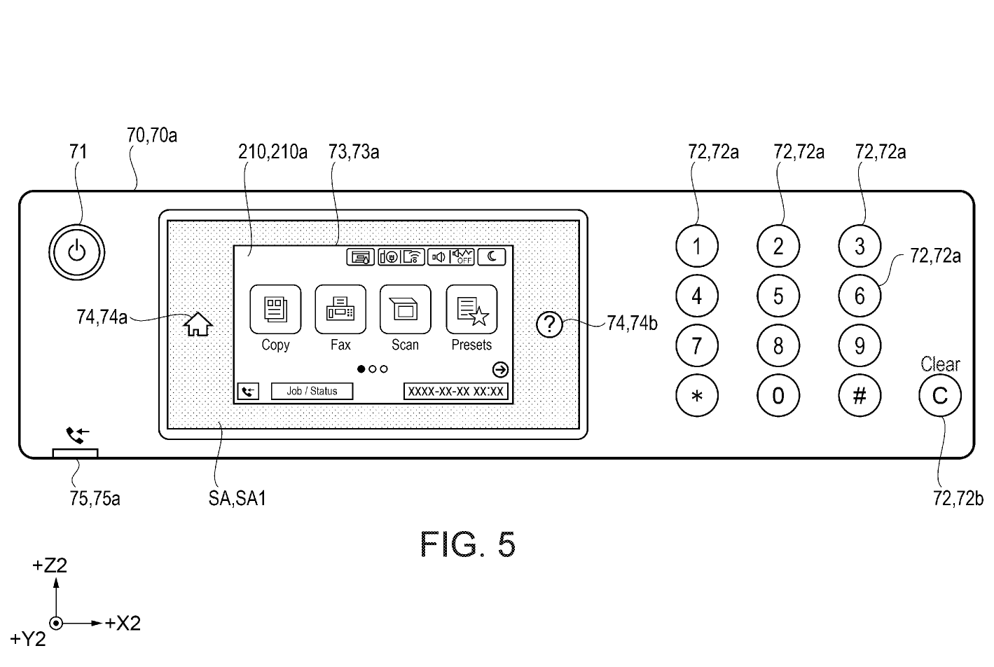

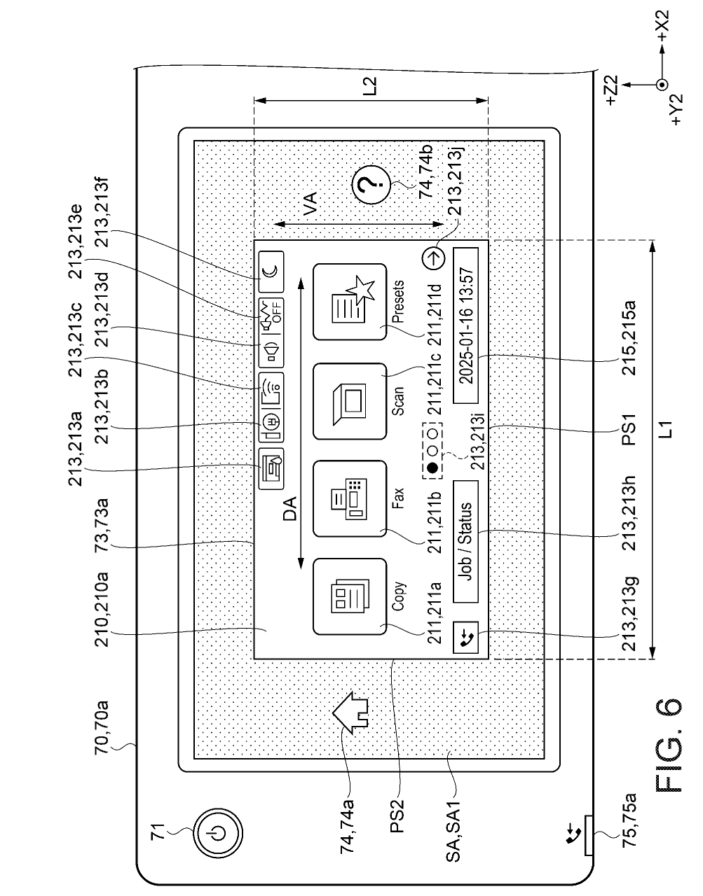

As illustrated in FIG. 5, the touch panel 73 displays a plurality of display screens 210. The display screen 210 displayed on the touch panel 73 is switched by a predetermined input operation by a user. The predetermined input operation is, for example, a scroll operation on the touch panel 73. As illustrated in FIG. 6, the display screen 210 displays a menu icon 211, a function icon 213, a display image 215, and the like.

The menu icon 211 is displayed in the display screen 210. The menu icon 211 receives touch input by a user. The menu icon 211 corresponds to an example of a touch key. One or more menu icons 211 are displayed in the display screen 210. When the plurality of menu icons 211 are displayed in the display screen 210, the plurality of menu icons 211 are arranged along an array axis DA. The menu icons 211 are displayed in a manner of moving along the array axis DA by an input operation by a user. The menu icon 211 is displayed in a first size, for example.

The menu icon 211 receives touch input by a user. When the user performs an input operation on the menu icon 211, the touch panel 73 generates a control signal. When the user performs an input operation on the menu icon 211, the touch panel 73 generates a control signal corresponding to the menu icon 211.

The function icon 213 is displayed in the display screen 210. One or more function icons 213 are displayed in the display screen 210. The function icon 213 is displayed at a predetermined position in the display screen 210. The function icon 213 may indicate various notifications to a user and a status of the printer 1. The function icon 213 is displayed in a second size smaller than the first size, for example.

The display image 215 is displayed in the display screen 210. One or more display images 215 are displayed in the display screen 210. The display image 215 is displayed at a predetermined position in the display screen 210. The display image 215 displays various types of information to be notified to a user.

The touch input key 74 receives touch input by a user. The touch input key 74 corresponds to an example of a soft key. The touch input key 74 is configured by a mechanism of a resistive film analog type, a capacitance type, an optical type, an infrared type, or the like. The touch input key 74 is desirably a capacitance type key of a capacitance type. The touch input key 74 is arranged in a sensor arrangement region SA (to be described later). The sensor arrangement region SA is provided on an outer peripheral section of the touch panel 73. When a user performs touch input on the touch input key 74, the touch input key 74 generates a control signal.

The control panel 70 includes the touch input key 74, and thus it is possible to add a function of the control panel 70 without updating a control program PG. The printer 1 can perform function extension by associating a function provided from a server or the like with the touch input key 74.

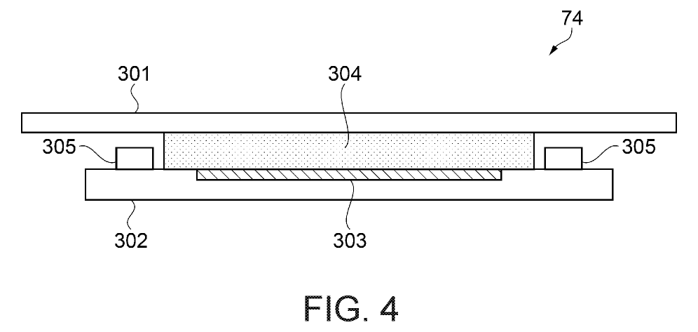

FIG. 4 illustrates an example of a schematic configuration of the touch input key 74. FIG. 4 illustrates the capacitance type touch input key 74. The touch input key 74 includes a cover film 301, an input key circuit substrate 302, an input key electrode 303, a light guide section 304, and light emitting elements 305.

The cover film 301 is arranged on an surface of the touch input key 74. The cover film 301 is contacted by a user. The cover film 301 is made of a material having light transmissivity. The cover film 301 is made of polycarbonate, for example. A key mark is formed on the cover film 301 at a position facing the input key electrode 303. The key mark is a figure or the like indicating a type of the touch input key 74.

The input key circuit substrate 302 is an electric circuit that transmits an electrical signal generated by the input key electrode 303 to the control unit 100. The input key circuit substrate 302 includes an electric circuit for operating the light emitting element 305. The input key circuit substrate 302 is arranged at a position facing the cover film 301.

The input key electrode 303 generates an electric field when the user touches the cover film 301. The input key electrode 303 is configured in a self-capacitance type configured by an electrode that generates an electric field or a mutual capacitance type configured by a transmission electrode and a reception electrode. The input key electrode 303 is arranged on the input key circuit substrate 302.

The light guide section 304 allows light emitted from the light emitting element 305 to pass therethrough. The light guide section 304 illuminates the key mark formed on the cover film 301 by transmitting light. The light guide section 304 is formed of a member having light transmissivity. The light guide section 304 is arranged between the cover film 301 and the input key circuit substrate 302.

The light emitting element 305 illuminates the key mark formed on the cover film 301 by emitting light. The light emitting element 305 is configured by a light emitting diode (LED) element or the like. The touch input key 74 illustrated in FIG. 4 includes two light emitting elements 305, but the present disclosure is not limited thereto. The number of the light emitting elements 305 is set as appropriate.

The touch input key 74 is desirably a capacitance type key.

By configuring the touch input key 74 as a capacitance type key, the operability and touch sensitivity of the touch input key 74 are improved.

The reading mechanism 80 illustrated in FIG. 3 is accommodated in the scanner unit 10. The reading mechanism 80 reads a document based on the control of the control unit 100. The reading mechanism 80 reads a document and generates read data. The reading mechanism 80 transmits the read data to the control unit 100. The reading mechanism 80 includes a reading sensor (not illustrated), a sensor carriage motor (not illustrated), and the like. The reading sensor reads a document and generates read data. The sensor carriage motor is a drive source that generates a drive force for moving the reading sensor.

The printing mechanism 90 performs printing based on the control of the control unit 100. The printing mechanism 90 receives print data from the control unit 100. The printing mechanism 90 performs printing based on the print data. The printing mechanism 90 includes various sensors (not illustrated). The printing mechanism 90 transmits detection signals detected by the various sensors to the control unit 100.

The power supply unit 95 supplies power to the control panel 70, the reading mechanism 80, the printing mechanism 90, and the like based on the control of the control unit 100. The power supply unit 95 changes its state under the control of the control unit 100. The power supply unit 95 changes its state between on and off under the control of the control unit 100. The power supply unit 95 changes its state to the operable state or the energy saving state under the control of the control unit 100.

The control unit 100 is a control controller that controls the control panel 70, the reading mechanism 80, the printing mechanism 90, and the like. The control unit 100 is, for example, a processor including a central processing unit (CPU). The control unit 100 is composed of one or more processors. The control unit 100 functions as various function sections by executing the control program PG. The control unit 100 functions as an input reception section 101, a display control section 102, a reading control section 103, a printing control section 104, and a power supply control section 105. The control unit 100 may function as a function section other than the input reception section 101, the display control section 102, the reading control section 103, the printing control section 104, and the power supply control section 105 by executing the control program PG.

The input reception section 101 receives a control signal transmitted from the control panel 70. The power button 71 and the like included in the control panel 70 generate the control signal when receiving an input operation by a user. The control panel 70 transmits the control signal generated by the power button 71 or the like to the control unit 100. The input reception section 101 receives the control signal transmitted from the control panel 70, thereby receiving the control signal. The input reception section 101 transmits the control signal to the display control section 102 and the like.

The display control section 102 controls display by the touch panel 73. The display control section 102 causes the touch panel 73 to display various display screens 210 such as a home screen 210a (to be described later). The display control section 102 displays the menu icon 211 and the like in the display screen 210. The display control section 102 may display various notification messages and the like. The touch panel 73 displays the display screen 210 and the like based on the control of the display control section 102.

The reading control section 103 controls the reading mechanism 80. The reading control section 103 causes the document transport mechanism to transport a document toward a position facing the reading sensor. The reading control section 103 causes the reading sensor to read the document. The reading control section 103 may cause the reading sensor to read a document placed on the document placement section.

The printing control section 104 controls the printing mechanism 90. The printing control section 104 causes the paper sheet transport section 22 to transport the paper sheet S onto the platen 45. The printing control section 104 causes the printing section 41 to execute printing on the paper sheet S. The printing control section 104 receives detection signals detected by various sensors provided in the printing mechanism 90. The printing control section 104 transmits the detection signals to the display control section 102, and causes the touch panel 73 to display various notifications.

The power supply control section 105 controls the power supply unit 95. The power supply control section 105 turns on the power supply unit 95 based on the power supply input instruction signal transmitted from the control panel 70. The power supply control section 105 turns off the power supply unit 95 based on the power supply disconnection instruction signal transmitted from the control panel 70. The power supply control section 105 changes the state of the power supply unit 95 from on to off or from off to on based on a control signal. The power supply control section 105 changes the state of the power supply unit 95 from the operable state to the energy saving state or from the energy saving state to the operable state based on a control signal.

The memory 110 stores various types of information, programs, and the like. The memory 110 stores the control program PG that causes the control unit 100 to operate as various function sections. The memory 110 stores various images to be displayed on the touch panel 73. The memory 110 is configured by a semiconductor memory such as a read only memory (ROM) or a random access memory (RAM).

The control program PG is firmware that causes the control unit 100 to function as various function sections. The control program PG is executed by the control unit 100. The control program PG causes the control unit 100 to function as the input reception section 101, the display control section 102, the reading control section 103, the printing control section 104, and the power supply control section 105.

FIG. 5 illustrates a schematic configuration of the control panel 70. FIG. 5 illustrates a schematic configuration of a first control panel 70a as an example of the control panel 70. The first control panel 70a includes the power button 71, the plurality of input buttons 72, a first touch panel 73a, a first sensor arrangement region SA1, the plurality of touch input keys 74, and the indicator lamp 75.

Figures, including FIG. 5, illustrate a coordinate system including an X2-axis, a Y2-axis, and a Z2-axis. The X2-axis is an axis parallel or substantially parallel to the X1-axis illustrated in FIG. 1. A +X2 direction is a direction from left to right when a user looks straight at the control panel 70. A -X2 direction is a direction from right to left when the user looks straight at the control panel 70. The Y2-axis is an axis orthogonal to a display surface of the touch panel 73. A +Y2 direction is a direction from the display surface of the touch panel 73 toward the front. A -Y2 direction is a direction from the display surface of the touch panel 73 toward the back. The Z2-axis is an axis orthogonal to the X2-axis and the Y2-axis. A +Z2 direction is a direction from the bottom to the top when the user looks straight at the control panel 70. A -Z2 direction is a direction from the top to the bottom when the user looks straight at the control panel 70.

The power button 71 is arranged at a position in the -X2 direction and a position in the +Z2 direction in the first control panel 70a. A position of the power button 71 is not limited to the position illustrated in FIG. 5. A position of the power button 71 is set as appropriate. The power button 71 may not be included in the first control panel 70a.

The plurality of input buttons 72 are arranged at positions in the +X2 direction of the first control panel 70a. The plurality of input buttons 72 arranged on the first control panel 70a include a plurality of number input buttons 72a and a clear button 72b.

The plurality of number input buttons 72a are used by a user to input numbers. When the user performs an input operation on the number input button 72a, number or the like corresponding to the number input button 72a is input. The plurality of number input buttons 72a correspond to numbers from 0 to 9, an asterisk symbol, and a pound symbol, respectively. A numeric keypad is formed by the plurality of number input buttons 72a.

The clear button 72b is used when a user deletes the input content. When the user performs an input operation on the clear button 72b, number or the like input by the user is deleted.

The plurality of number input buttons 72a and the clear button 72b are arranged on the first control panel 70a, but the present disclosure is not limited thereto. The first control panel 70a may include the input button 72 other than the plurality of number input buttons 72a and the clear button 72b. The first control panel 70a may or may not include the plurality of number input buttons 72a and the clear button 72b.

The first touch panel 73a is an example of the touch panel 73. The first touch panel 73a is arranged at a position between the power button 71 and the plurality of input buttons 72 along the X2-axis. The first touch panel 73a illustrated in FIG. 5 displays the home screen 210a, which is an example of the display screen 210. Details of the home screen 210a will be described later.

The first sensor arrangement region SA1 is an example of the sensor arrangement region SA. The sensor arrangement region SA is a region in which the plurality of touch input keys 74 are provided. The first sensor arrangement region SA1 is provided on an outer peripheral section of the first touch panel 73a.

The plurality of touch input keys 74 are arranged in the first sensor arrangement region SA1. The plurality of touch input keys 74 arranged in the first sensor arrangement region SA1 are provided on the outer peripheral section of the first touch panel 73a. By arranging the touch input keys 74 in the first sensor arrangement region SA1, the operability of a user with respect to the menu icons 211 and the touch input keys 74 displayed on the first touch panel 73a is improved. The plurality of touch input keys 74 arranged on the first control panel 70a are a home key 74a and a help key 74b.

The home key 74a is operated by a user to display the home screen 210a on the first touch panel 73a. When the user performs an input operation on the home key 74a, the first touch panel 73a displays the home screen 210a. The home key 74a provided on the first control panel 70a is arranged at a position in the -X2 direction of the first touch panel 73a. The home key 74a provided on the first control panel 70a corresponds to an example of the soft key.

The help key 74b is operated when a user causes the first touch panel 73a to display a help screen (not illustrated). When the user performs an input operation on the help key 74b, the first touch panel 73a displays the help screen. The help key 74b provided on the first control panel 70a is arranged at a position in the +X2 direction of the first touch panel 73a. The help key 74b provided on the first control panel 70a corresponds to an example of a second soft key.

The indicator lamp 75 is turned on or off when a user is notified. The first touch panel 73a includes an unprocessed notification lamp 75a, which is an example of the indicator lamp 75. The unprocessed notification lamp 75a notifies a user that unprocessed data is stored in the memory 110. One indicator lamp 75 is provided on the first control panel 70a, but the present disclosure is not limited thereto. The number of the indicator lamps 75 can be set as appropriate.

FIG. 6 illustrates a schematic configuration of the control panel 70. FIG. 6 illustrates a schematic configuration of the first control panel 70a as an example of the control panel 70. FIG. 6 illustrates an enlarged view of the vicinity of the first touch panel 73a of the first control panel 70a. FIG. 6 illustrates the first touch panel 73a and the plurality of touch input keys 74 provided on the first sensor arrangement region SA1.

The first touch panel 73a illustrated in FIG. 6 displays the home screen 210a. The home screen 210a displays the plurality of menu icons 211, the plurality of function icons 213, and the display image 215.

The plurality of menu icons 211 are displayed along the array axis DA. The array axis DA of the first control panel 70a is an axis parallel or substantially parallel to the X2-axis. The array axis DA corresponds to an example of a first axis. The plurality of menu icons 211 are displayed so as to be movable along the array axis DA by a scroll operation by a user. The plurality of menu icons 211 displayed on the home screen 210a are, for example, a copy icon 211a, a fax icon 211b, a scanner icon 211c, and a preset icon 211d.

The copy icon 211a is operated when a user copies a document. When the user performs an input operation on the copy icon 211a, the printer 1 reads a document and performs printing based on the read data.

The fax icon 211b is operated when a user performs fax transmission. When the user performs an input operation on the fax icon 211b, the printer 1 reads a document and transmits the read data to the outside via a telephone line.

The scanner icon 211c is operated when a user reads a document and obtains read data When the user performs an input operation on the scanner icon 211c, the printer 1 reads a document and generates the read data. The printer 1 stores the read data in the memory 110 or the like.

The preset icon 211d is operated when a user performs various settings. When the user performs an input operation on the preset icon 211d, a preset screen (not illustrated) is displayed on the first touch panel 73a. The preset screen is a screen for inputting various settings such as a paper sheet size and duplex/single-sided printing. A user performs various settings by performing input operations on the preset screen.

The plurality of function icons 213 are arranged at a position in the +Z2 direction and a position in the - Z2 direction in the first touch panel 73a. The plurality of function icons 213 are fixedly arranged in the first touch panel 73a. The plurality of function icons 213 arranged at positions in the +Z2 direction in the first touch panel 73a are a status display icon 213a, a LAN connection notification icon 213b, a simple AP connection notification icon 213c, a sound setting icon 213d, an operating sound reduction mode notification icon 213e, and a sleep mode setting icon 213f. The plurality of function icons 213 arranged at positions in the -Z2 direction in the first touch panel 73a are a fax notification icon 213g, a job status notification icon 213h, a screen position notification icon 213i, and a first scroll icon 213j.

The status display icon 213a is operated when a user confirms a status of the printer 1. When the user performs an input operation on the status display icon 213a, the first touch panel 73a displays a status notification screen illustrating an ink remaining amount and other printer 1 status. The status notification screen is not illustrated. The status notification screen is an example of the display screen 210.

The LAN connection notification icon 213b displays a connection state of a local area network (LAN). A display mode of the LAN connection notification icon 213b differs depending on whether or not the printer 1 is connected to the LAN. A user can confirm whether or not the printer 1 is connected to the LAN by viewing the LAN connection notification icon 213b.

The simple AP connection notification icon 213c displays whether or not the printer 1 is connected to other devices as access points. A display mode of the simple AP connection notification icon 213c differs depending on whether or not the device is connected to other devices via a simple AP. A user can confirm whether or not the printer 1 is connected to other devices via the simple AP by viewing the simple AP connection notification icon 213c.

The sound setting icon 213d is operated when a user adjusts an output sound of the printer 1. When the user performs an input operation on the sound setting icon 213d, the first touch panel 73a displays an output sound setting screen for receiving a setting of an output sound. The output sound setting screen is not illustrated. The output sound setting screen is an example of the display screen 210.

The operating sound reduction mode notification icon 213e displays whether or not an operating sound reduction mode is set. The operating sound reduction mode is a mode for suppressing an operating sound of the printer 1. A display mode of the operating sound reduction mode notification icon 213e differs depending on whether or not the operating sound reduction mode is set. A user can confirm whether or not the operating sound reduction mode is set by viewing the operating sound reduction mode notification icon 213e.

The sleep mode setting icon 213f displays whether or not the sleep mode is set. The sleep mode is a mode in which the printer 1 is operated in an energy saving state. A display mode of the sleep mode setting icon 213f differs depending on whether or not the sleep mode is set. A user can confirm whether or not the sleep mode is set by viewing the sleep mode setting icon 213f.

The fax notification icon 213g is operated when a user confirms the presence or absence of fax data. When the user performs an input operation on the fax notification icon 213g, the first touch panel 73a displays a fax data information screen (not illustrated). The fax data information screen is a screen for displaying unprocessed fax data. The fax data information screen is an example of the display screen 210.

The job status notification icon 213h is operated when a user confirms a job execution status of the printer 1. When the user performs an input operation on the job status notification icon 213h, the first touch panel 73a displays a job list screen (not illustrated). The job list screen displays information about jobs being executed by the printer 1 and jobs waiting to be executed. The job list screen is an example of the display screen 210.

The screen position notification icon 213i indicates a type of the display screen 210 displayed on the first touch panel 73a. The display control section 102 displays the plurality of display screens 210 on the first touch panel 73a. The first touch panel 73a switches the display screen 210 to be displayed in accordance with a scroll operation by a user. The screen position notification icon 213i indicates a type of the display screen 210 switched in accordance with the scroll operation.

The first scroll icon 213j is operated when a user switches the display screen 210. When the user performs an input operation on the first scroll icon 213j, the first touch panel 73a displays a first menu icon display screen 210b including the menu icons 211 arranged in the +X2 direction. The first menu icon display screen 210b is an example of the display screen 210. The first menu icon display screen 210b will be described later.

The display image 215 is displayed at a position in the -Z2 direction in the home screen 210a. The home screen 210a displays a date and time display image 215a, which is an example of the display image 215. The date and time display image 215a indicates the date and time. The date and time display image 215a is always displayed regardless of a type of the display screen 210 when the display screen 210 is switched by a user.

The first touch panel 73a is rectangular and has a first panel side PS1 with a first panel side length L1 and a second panel side PS2 with a second panel side length L2. The first panel side PS1 is a side along the array axis DA. The first panel side PS1 corresponds to an example of a first side. The first panel side length L1 corresponds to an example of a first length. The second panel side PS2 is a side along an orthogonal axis VA orthogonal to the array axis DA. The second panel side PS2 corresponds to an example of a second side. The second panel side length L2 corresponds to an example of a second length. The orthogonal axis VA corresponds to an example of a second axis.

In the first touch panel 73a, the first panel side length L1 is longer than the second panel side length L2. By configuring the first panel side length L1 of the first panel side PS1 along the array axis DA to be longer than the second panel side length L2, the operability of an scroll operation performed by a user is improved.

The plurality of touch input keys 74 are arranged in the first sensor arrangement region SA1. The plurality of touch input keys 74 are the home key 74a and the help key 74b. The home key 74a is arranged at a position in the -X2 direction of the first touch panel 73a. The help key 74b is arranged at a position in the +X2 direction of the first touch panel 73a. The home key 74a, the help key 74b, and the first touch panel 73a are arranged in an order of the home key 74a, the first touch panel 73a, and the help key 74b along the array axis DA. The home key 74a and the help key 74b are arranged with the first touch panel 73a interposed therebetween, and thus a user is prevented from erroneously operating the home key 74a and the help key 74b. The home key 74a and the help key 74b are arranged along the first panel side PS1 having the first panel side length L1 that is longer than the second panel side length L2. By this, the erroneous operation by the user on the home key 74a and the help key 74b is further prevented.

The printer 1 includes the first control panel 70a that receives an input operation by a user, including touch input. The first control panel 70a includes the power button 71, the first touch panel 73a that displays the plurality of menu icons 211, and the home key 74a. The power button 71 receives state change of the power supply unit 95. The plurality of menu icons 211 receive touch input by the user. The home key 74a receives touch input by the user. The home key 74a is provided on an outer peripheral section of the first touch panel 73a.

The touch input keys 74 are provided on the outer peripheral section of the first touch panel 73a, and thus the operability of a user with respect to the touch input keys 74 and the first touch panel 73a is improved.

The first control panel 70a includes the help key 74b that receives touch input by a user. The help key 74b is provided on the outer peripheral section of the first touch panel 73a. The first touch panel 73a displays the plurality of menu icons 211 along the array axis DA. The home key 74a, the help key 74b, and the first touch panel 73a are arranged in an order of the home key 74a, the first touch panel 73a, and the help key 74b along the array axis DA.

The home key 74a and the help key 74b are arranged with the first touch panel 73a interposed therebetween, and thus a user is prevented from erroneously operating the home key 74a and the help key 74b.

The first touch panel 73a is rectangular and has the first panel side PS1 along the array axis DA and the second panel side PS2 along the orthogonal axis VA orthogonal to the array axis DA. It is desirable that the first panel side length L1 of the first panel side PS1 be longer than the second panel side length L2 of the second panel side PS2.

By arranging the home key 74a and the help key 74b along the first panel side PS1, the erroneous operation by a user on the home key 74a and the help key 74b is further prevented.

The plurality of menu icons 211 are desirably displayed so as to be movable along the array axis DA.

A user can easily distinguish between the menu icons 211 displayed movably and the touch input key 74 arranged fixedly, such as the home key 74a. An erroneous operation by the user with respect to the home key 74a or the like is prevented.

The first control panel 70a includes the power button 71, the first touch panel 73a that displays the plurality of menu icons 211, and the home key 74a that receives touch input by a user. The power button 71 receives state change of the power supply unit 95. The plurality of menu icons 211 receive touch input by the user. The home key 74a is provided on an outer peripheral section of the first touch panel 73a.

The touch input keys 74 are provided on the outer peripheral section of the first touch panel 73a, and thus the operability of the user with respect to the touch input keys 74 and the first touch panel 73a is improved.

The first control panel 70a includes the help key 74b that receives touch input by the user. The help key 74b is provided on the outer peripheral section of the first touch panel 73a. The first touch panel 73a displays the plurality of menu icons 211 along the array axis DA. The home key 74a, the help key 74b, and the first touch panel 73a are arranged in an order of the home key 74a, the first touch panel 73a, and the help key 74b along the array axis DA.

The home key 74a and the help key 74b are arranged with the first touch panel 73a interposed therebetween, and thus the user is prevented from erroneously operating the home key 74a and the help key 74b.

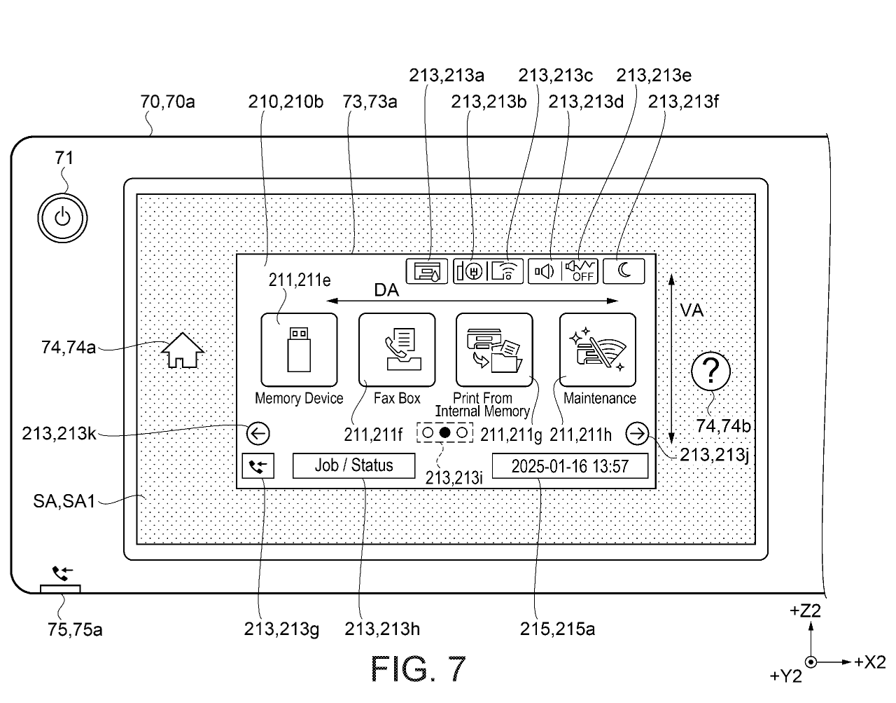

FIG. 7 illustrates a schematic configuration of the control panel 70. FIG. 7 illustrates a schematic configuration of the first control panel 70a as an example of the control panel 70. FIG. 7 illustrates an enlarged view of the vicinity of the first touch panel 73a of the first control panel 70a. FIG. 7 illustrates the first touch panel 73a and the plurality of touch input keys 74 provided on the first sensor arrangement region SA1. FIG. 7 illustrates the first touch panel 73a that displays a first menu icon display screen 210b. The first control panel 70a illustrated in FIG. 7 includes the same configuration as the first control panel 70a illustrated in FIG. 6 except for the first menu icon display screen 210b displayed on the first touch panel 73a.

The first menu icon display screen 210b is displayed on the first touch panel 73a when a user performs a scroll operation in the - X2 direction on the home screen 210a illustrated in FIG. 6. Alternatively, the first menu icon display screen 210b is displayed on the first touch panel 73a when the user performs an input operation on the first scroll icon 213j displayed on the home screen 210a illustrated in FIG. 6.

The first menu icon display screen 210b displays the plurality of menu icons 211, the plurality of function icons 213, and the display image 215. The plurality of function icons 213 displayed on the first menu icon display screen 210b are the same as the plurality of function icons 213 displayed on the home screen 210a, except for a second scroll icon 213k. The display image 215 displayed on the first menu icon display screen 210b is the same as the display image 215 displayed on the home screen 210a.

The plurality of menu icons 211 displayed on the first menu icon display screen 210b are displayed along the array axis DA. The plurality of menu icons 211 are displayed so as to be movable along the array axis DA by a scroll operation by a user. The plurality of menu icons 211 are, for example, an external memory print icon 211e, a fax box icon 211f, an internal memory print icon 211g, and a maintenance icon 211h.

The external memory print icon 211e is operated by a user when printing data stored in an external memory. The external memory is, for example, a universal serial bus (USB) memory, and is connected to a connection terminal (not illustrated) provided in the printer 1. When the user performs an input operation on the external memory print icon 211e, the first touch panel 73a displays an external memory information screen illustrating information related to data stored in the external memory. The external memory information screen is not illustrated. The external memory information screen is an example of the display screen 210.

The fax box icon 211f is operated when a user confirms a fax document received by the printer 1. When the user performs an input operation on the fax box icon 211f, the first touch panel 73a displays a fax box screen illustrating information related to a received document or the like stored in the fax box. The fax box screen is not illustrated. The fax box screen is an example of the display screen 210.

The internal memory print icon 211g is operated by a user when printing print data stored in the memory 110. When the user performs an input operation on the internal memory print icon 211g, the first touch panel 73a displays a data list screen illustrating information related to the print data. The data list screen is not illustrated. The data list screen is an example of the display screen 210.

The maintenance icon 211h is operated when a user performs maintenance of the printer 1. When the user performs an input operation on the maintenance icon 211h, the first touch panel 73a displays a maintenance menu screen illustrating information related to maintenance. The maintenance menu screen is not illustrated. The maintenance menu screen is an example of the display screen 210.

The second scroll icon 213k is operated when a user switches the display screen 210. When the user performs an input operation on the second scroll icon 213k, the display screen 210 of the first touch panel 73a scrolls in the +X2 direction. When the user performs an input operation on the second scroll icon 213k in a state where the first menu icon display screen 210b is displayed, the first touch panel 73a displays the home screen 210a.

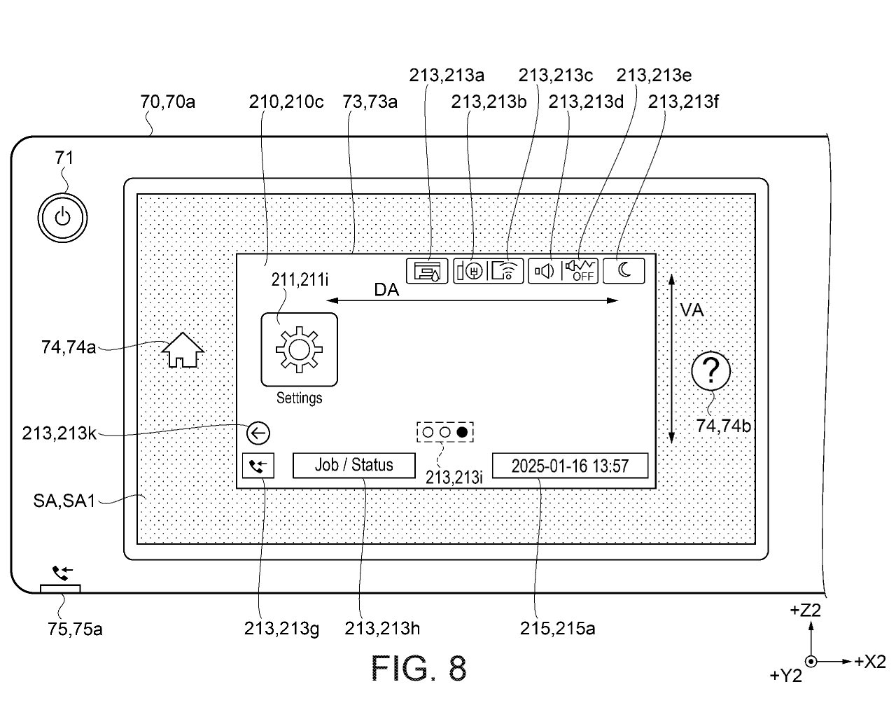

FIG. 8 illustrates a schematic configuration of the control panel 70. FIG. 8 illustrates a schematic configuration of the first control panel 70a as an example of the control panel 70. FIG. 8 illustrates an enlarged view of the vicinity of the first touch panel 73a of the first control panel 70a. FIG. 8 illustrates the first touch panel 73a and the plurality of touch input keys 74 provided on the first sensor arrangement region SA1. FIG. 8 illustrates the first touch panel 73a that displays a second menu icon display screen 210c. The first control panel 70a illustrated in FIG. 8 includes the same configuration as the first control panel 70a illustrated in FIG. 6 except for the second menu icon display screen 210c displayed on the first touch panel 73a.

The second menu icon display screen 210c is displayed on the first touch panel 73a when a user performs a scroll operation in the -X2 direction on the first menu icon display screen 210b illustrated in FIG. 7. Alternatively, the second menu icon display screen 210c is displayed on the first touch panel 73a when the user performs an input operation on the first scroll icon 213j displayed on the first menu icon display screen 210b illustrated in FIG. 7.

The second menu icon display screen 210c displays the menu icon 211, the plurality of function icons 213, and the display image 215. The plurality of function icons 213 displayed on the second menu icon display screen 210c are the same as the plurality of function icons 213 displayed on the first menu icon display screen 210b except that the first scroll icon 213j is not displayed. The display image 215 displayed on the second menu icon display screen 210c is the same as the display image 215 displayed on the home screen 210a and the first menu icon display screen 210b.

The menu icon 211 displayed on the second menu icon display screen 210c is displayed so as to be movable along the array axis DA by a scroll operation by a user. The menu icon 211 is, for example, a setting icon 211i. The second menu icon display screen 210c illustrated in FIG. 8 displays one menu icon 211, but the present disclosure is not limited thereto. The second menu icon display screen 210c may display the plurality of menu icons 211. The number of the menu icons 211 displayed on the second menu icon display screen 210c is set as appropriate.

The setting icon 211i is operated when a user performs various settings related to the printer 1. When the user performs an input operation on the setting icon 211i, the first touch panel 73a displays a setting screen related to settings of the printer 1. The setting screen is not illustrated. The setting screen is an example of the display screen 210.

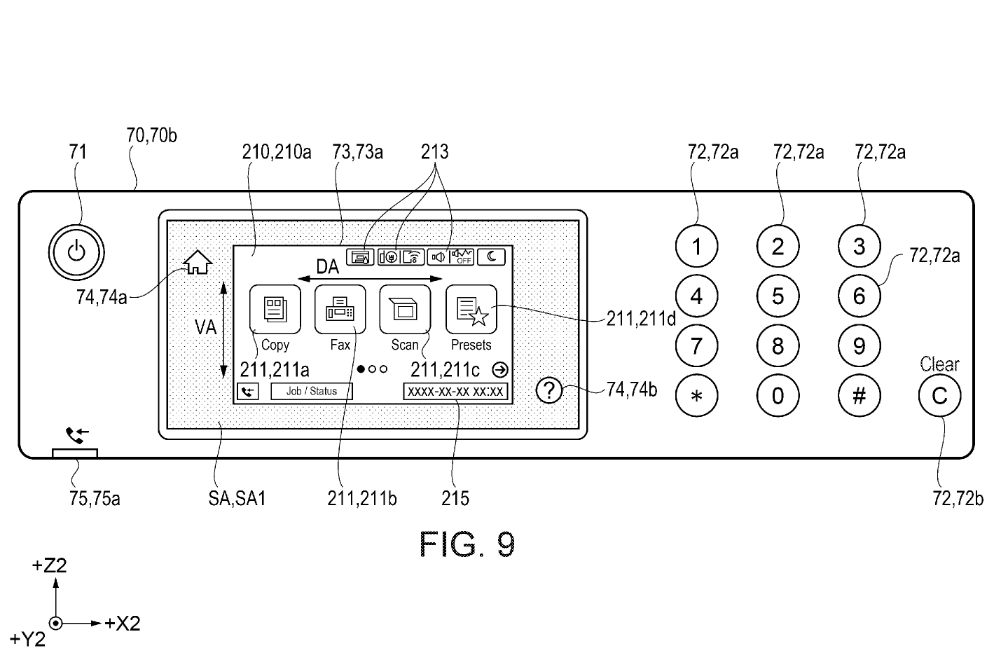

FIG. 9 illustrates a schematic configuration of the control panel 70. FIG. 9 illustrates a schematic configuration of a second control panel 70b as an example of the control panel 70. The second control panel 70b includes the power button 71, the plurality of input buttons 72, the first touch panel 73a, the first sensor arrangement region SA1, the plurality of touch input keys 74, and the indicator lamp 75. The power button 71 may not be included in the second control panel 70b. A configuration of the second control panel 70b illustrated in FIG. 9 is the same as the configuration of the first control panel 70a illustrated in FIG. 5 except for the arrangement of the plurality of touch input keys 74 arranged in the first sensor arrangement region SA1.

The home key 74a and the help key 74b are arranged as the plurality of touch input keys 74 in the first sensor arrangement region SA1 of the second control panel 70b. The home key 74a is arranged at a position in the +Z2 direction from the plurality of menu icons 211 displayed in the first touch panel 73a. The help key 74b is arranged at a position in the -Z2 direction from the plurality of menu icons 211. The home key 74a, the help key 74b, and the first touch panel 73a are arranged in an order of the home key 74a, the first touch panel 73a, and the help key 74b along the array axis DA.

Positions of the home key 74a and the help key 74b along the Z2-axis can be set as appropriate. The home key 74a and the help key 74b may be arranged at a position in the +Z2 direction or a position in the -Z2 direction from the plurality of menu icons 211. The home key 74a and the help key 74b are arranged in an order of the home key 74a, the first touch panel 73a, and the help key 74b along the array axis DA, regardless of positions along the Z2-axis.

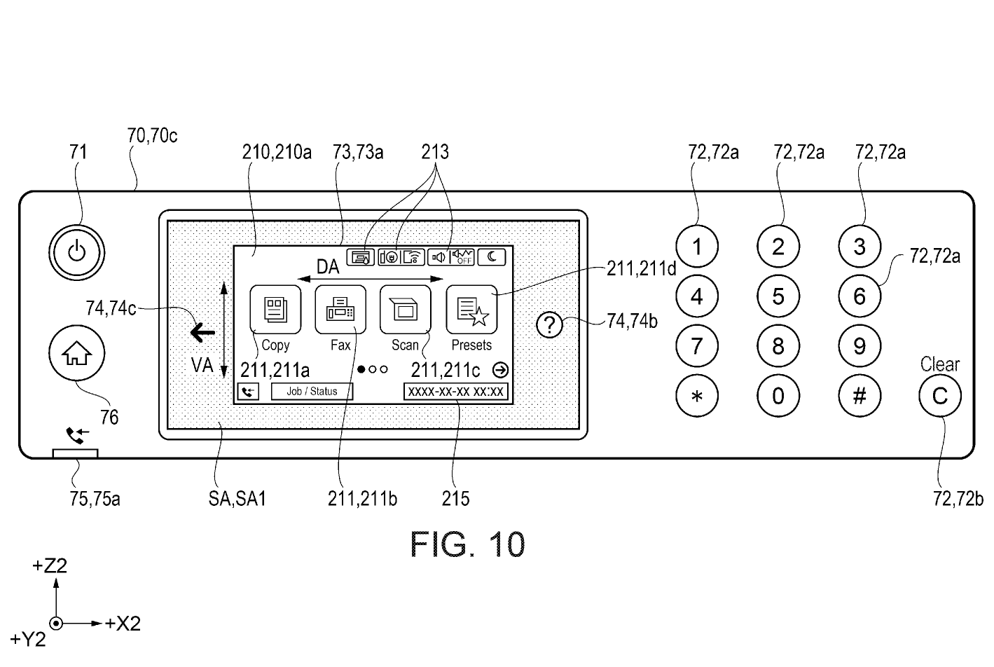

FIG. 10 illustrates a schematic configuration of the control panel 70. FIG. 10 illustrates a schematic configuration of a third control panel 70c as an example of the control panel 70. The third control panel 70c includes the power button 71, the plurality of input buttons 72, the first touch panel 73a, the first sensor arrangement region SA1, the plurality of touch input keys 74, the indicator lamp 75, and a home button 76. The power button 71 may not be included in the third control panel 70c. A configuration of the third control panel 70c illustrated in FIG. 10 is the same as the configuration of the first control panel 70a illustrated in FIG. 5 except for the plurality of touch input keys 74 arranged in the first sensor arrangement region SA1 and the home button 76.

A back key 74c and the help key 74b are arranged as the plurality of touch input keys 74 in the first sensor arrangement region SA1 of the third control panel 70c. The back key 74c is arranged at a position in the -X2 direction from the first touch panel 73a. The back key 74c in the third control panel 70c corresponds to an example of the soft key. The help key 74b is arranged at a position in the +X2 direction from the first touch panel 73a. The help key 74b in the third control panel 70c corresponds to an example of the second soft key. The back key 74c, the help key 74b, and the first touch panel 73a are arranged in an order of the back key 74c, the first touch panel 73a, and the help key 74b along the array axis DA.

The back key 74c is operated by a user. When the first touch panel 73a displays the display screen 210 other than the home screen 210a, the user performs an input operation on the back key 74c. When the user performs an input operation on the back key 74c, the first touch panel 73a displays another display screen 210 displayed immediately before the display screen 210 that was displayed when the back key 74c was operated.

The home button 76 is configured by a mechanical mechanism that mechanically switches an electrical signal. The home button 76 receives an input operation by a user. When the user performs an input operation on the home button 76, the first touch panel 73a displays the home screen 210a. The home button 76 has the same function as the home key 74a.

The home button 76 of the third control panel 70c is arranged at a position in the -X2 direction of the first touch panel 73a and the first sensor arrangement region SA1. The home button 76 of the third control panel 70c is arranged at a position in the -Z2 direction of the power button 71.

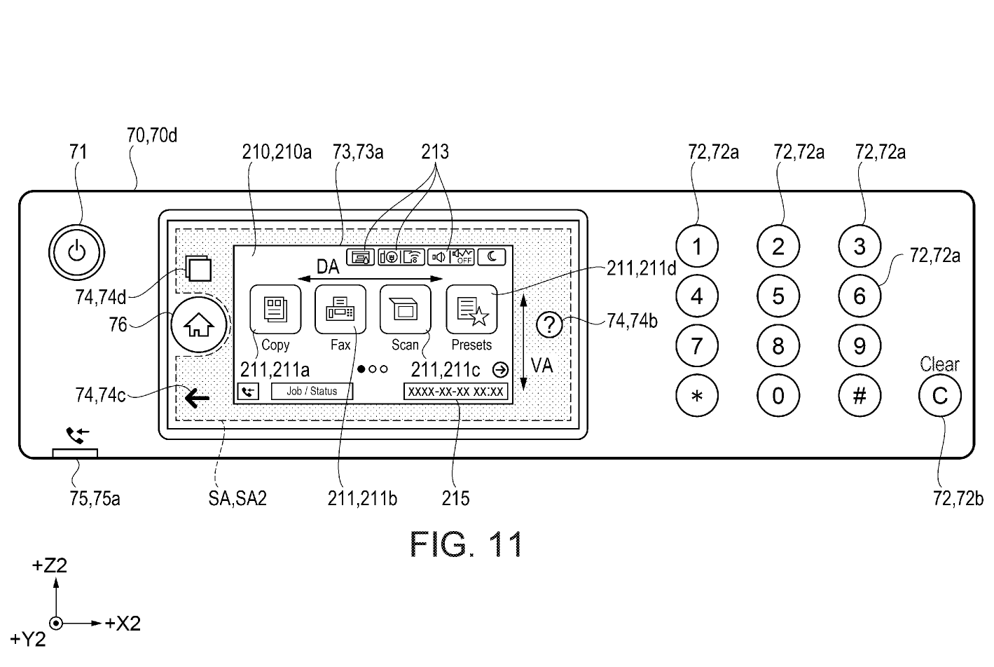

FIG. 11 illustrates a schematic configuration of the control panel 70. FIG. 11 illustrates a schematic configuration of a fourth control panel 70d as an example of the control panel 70. The fourth control panel 70d includes the power button 71, the plurality of input buttons 72, the first touch panel 73a, a second sensor arrangement region SA2, the plurality of touch input keys 74, the indicator lamp 75, and the home button 76. The power button 71 may not be included in the fourth control panel 70d. The fourth control panel 70d differs from the first control panel 70a illustrated in FIG. 5 in a configuration of the sensor arrangement region SA, the arrangement of the plurality of touch input keys 74, and the home button 76. The fourth control panel 70d has the same configuration as the first control panel 70a illustrated in FIG. 5 except for the configuration of the sensor arrangement region SA, the arrangement of the plurality of touch input keys 74, and the home button 76.

The second sensor arrangement region SA2 is an example of the sensor arrangement region SA. The second sensor arrangement region SA2 is provided on an outer peripheral section of the first touch panel 73a. The second sensor arrangement region SA2 is formed in a shape that avoids a position where the home button 76 is arranged.

In the second sensor arrangement region SA2, the help key 74b, the back key 74c, and a server switching key 74d are arranged as the plurality of touch input keys 74. The help key 74b, the back key 74cc, and the server switching key 74d are provided on the outer peripheral section of the first touch panel 73a.

The help key 74b in the fourth control panel 70d is arranged at a position in the +X2 direction of the first touch panel 73a. The help key 74b in the fourth control panel 70d corresponds to an example of the second soft key.

The back key 74c in the fourth control panel 70d is arranged at a position in the -X2 direction of the first touch panel 73a. The back key 74c in the fourth control panel 70d corresponds to an example of the soft key.

The server switching key 74d is operated when a user switches a server connected to the printer 1. The server switching key 74d receives touch input by the user. The control unit 100 is connected to the server via a communication unit (not illustrated). When the user performs an input operation on the server switching key 74d, the control unit 100 switches the server to be connected. The server switching key 74din the fourth control panel 70d is arranged at an arrangement position in the -X2 direction of the first touch panel 73a. The server switching key 74d is arranged at an arrangement position in the +Z2 direction of the back key 74c. The +Z2 direction intersects the array axis DA. The +Z2 direction corresponds to an example of a first direction. The server switching key 74d corresponds to an example of a third soft key. By arranging the server switching key 74d at the arrangement position in the +Z2 direction of the back key 74c, the operability of the user with respect to the back key 74c and the server switching key 74d is improved.

The home button 76 in the fourth control panel 70d is arranged at a position in the -X2 direction of the first touch panel 73a. The home button 76 in the fourth control panel 70d corresponds to an example of a mechanical key. The home button 76 is arranged at a position in the +Z2 direction of the back key 74c and in the -Z2 direction of the server switching key 74d. The back key 74c, the server switching key 74d, and the home button 76 are arranged in an order of the back key 74c, the home button 76, and the server switching key 74d along the orthogonal axis VA. By arranging them in this order along the orthogonal axis VA, the accessibility of the user to the menu icon 211, the plurality of touch input keys 74, and the home button 76 is improved.

The back key 74cmay be arranged at a position in the +X2 direction or a position in the -X2 direction from the home button 76. The server switching key 74d may be arranged at an arrangement position in the +X2 direction or an arrangement position in the -X2 direction from the home button 76.

The fourth control panel 70d includes the server switching key 74d that receives touch input by a user. The server switching key 74d is provided on an outer peripheral section of the first touch panel 73a. The server switching key 74d is desirably arranged at an arrangement position in the +Z2 direction intersecting the array axis DA with respect to the back key 74c.

By arranging the server switching key 74d at an arrangement position in the +Z2 direction of the back key 74c, the operability of the user with respect to the back key 74c and the server switching key 74d is improved.

The fourth control panel 70d includes the home button 76 that receives an input operation by a user. The back key 74c, the server switching key 74d, and the home button 76 are desirably arranged in an order of the back key 74c, the home button 76, and the server switching key 74d along the orthogonal axis VA.

By arranging the back key 74c and the server switching key 74d with the home button 76 of a mechanical mechanism interposed therebetween along the orthogonal axis VA, the user can easily distinguish the back key 74c and the server switching key 74d.

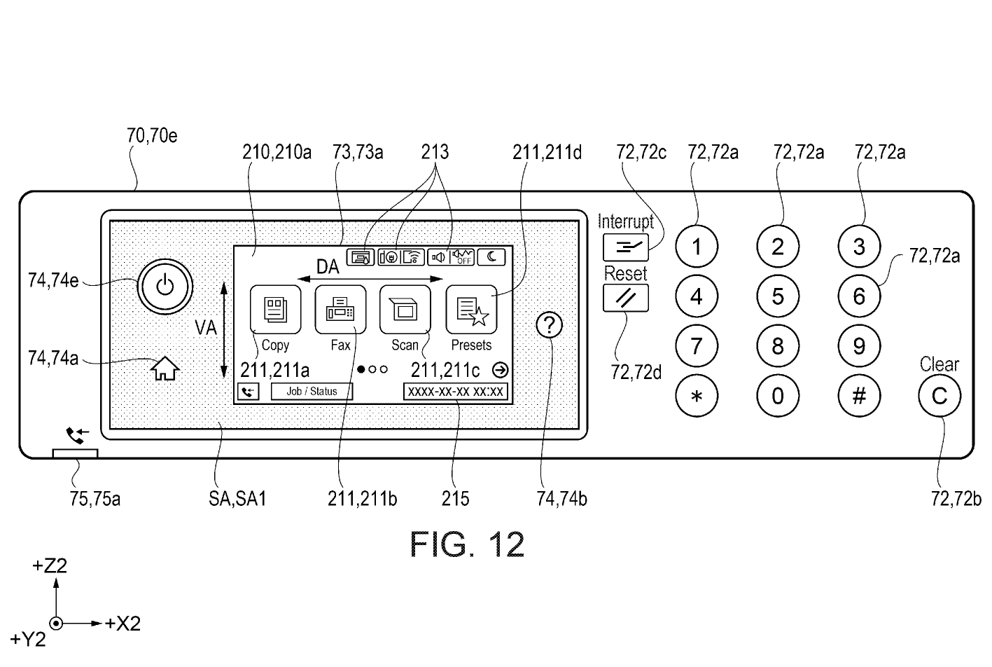

FIG. 12 illustrates a schematic configuration of the control panel 70. FIG. 12 illustrates a schematic configuration of a fifth control panel 70e as an example of the control panel 70. The fifth control panel 70e includes the plurality of input buttons 72, the first touch panel 73a, the first sensor arrangement region SA1, the plurality of touch input keys 74, and the indicator lamp 75. A configuration of the fifth control panel 70e differs from the configuration of the first control panel 70a illustrated in FIG. 5 in that the fifth control panel 70e does not include the power button 71, the number and arrangement of the input buttons 72, and the number and arrangement of the touch input keys 74. The configuration of the fifth control panel 70e is the same as the configuration of the first control panel 70a illustrated in FIG. 5 except that the fifth control panel 70e does not include the power button 71, the number and arrangement of the input buttons 72, and the number and arrangement of the touch input keys 74.

The fifth control panel 70e includes the plurality of number input buttons 72a, the clear button 72b, an interrupt button 72c, and a reset button 72d as the plurality of input buttons 72. The plurality of number input buttons 72a and the clear button 72b in the fifth control panel 70e are the same as the plurality of number input buttons 72a and the clear button 72b in the first control panel 70a illustrated in FIG. 5.

The interrupt button 72c receives an input operation by a user. The interrupt button 72c is operated when the user interrupts the printing being executed and executes printing or copying of the received print data.

The reset button 72d receives an input operation by a user. When the user performs an input operation on the reset button 72d, the control unit 100 returns various settings set by the user to initial values.

In the first sensor arrangement region SA1, the home key 74a, the help key 74b, and a power key 74e are arranged as the plurality of touch input keys 74. The home key 74a, the help key 74b, and the power key 74e are arranged on an outer peripheral section of the first touch panel 73a.

The home key 74a in the fifth control panel 70e is arranged at a position in the -X2 direction of the first touch panel 73a. The home key 74a is arranged at a position in the -Z2 direction from the plurality of menu icons 211 displayed on the first touch panel 73a.

The help key 74b in the fifth control panel 70e is arranged at a position in the +X2 direction of the first touch panel 73a.

The power key 74e receives touch input by a user. The power key 74e receives, as input operations, the power supply input instruction operation and the power supply disconnection instruction operation for instructing state change of the power supply unit 95. The power supply unit 95 may receive state change based on a control signal from the power key 74e, which is the touch input key 74. The power key 74e has the same function as the power button 71. The power key 74e corresponds to an example of the power switch.

The power key 74e is arranged at a position in the -X2 direction of the first touch panel 73a. The power key 74e is arranged at a position in the +Z2 direction of the home key 74a. The power key 74e is arranged at a position in the +Z2 direction from the plurality of menu icons 211 displayed on the first touch panel 73a.

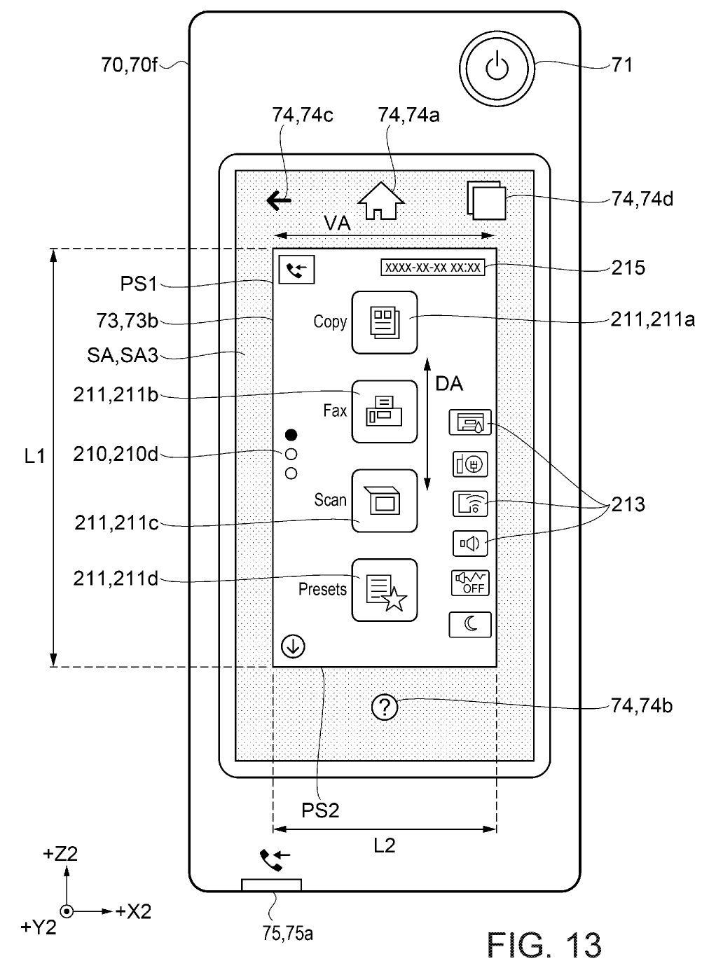

FIG. 13 illustrates a schematic configuration of the control panel 70. FIG. 13 illustrates a schematic configuration of a sixth control panel 70f as an example of the control panel 70. The sixth control panel 70f includes the power button 71, a second touch panel 73b, a third sensor arrangement region SA3, the plurality of touch input keys 74, and the indicator lamp 75. The power button 71 may not be included in the sixth control panel 70f.

The sixth control panel 70f is configured as a rectangle whose length along the Z2-axis is longer than its length along the X2-axis. The sixth control panel 70f illustrated in FIG. 13 does not include the input button 72, but the present disclosure is not limited thereto. The sixth control panel 70f may include the input button 72.

The power button 71 in the sixth control panel 70f is arranged at a position in the +Z2 direction from the second touch panel 73b and the third sensor arrangement region SA3. A position of the power button 71 is not limited to a position in the +Z2 direction from the second touch panel 73b and the third sensor arrangement region SA3. A position of the power button 71 may be a position in the -Z2 direction from the second touch panel 73b and the third sensor arrangement region SA3.

The second touch panel 73b is an example of the touch panel 73. The second touch panel 73b is rectangular and has the first panel side PS1 with the first panel side length L1 and the second panel side PS2 with the second panel side length L2. The first panel side PS1 is a side along the array axis DA. The second panel side PS2 is a side along an orthogonal axis VA orthogonal to the array axis DA. The second touch panel 73b is arranged at a position in the -Z2 direction of the power button 71. The second touch panel 73b illustrated in FIG. 13 displays a second home screen 210d.

The second home screen 210d is an example of the display screen 210. The second home screen 210d displays the plurality of menu icons 211, the plurality of function icons 213, and the display image 215. The plurality of menu icons 211 and the like displayed on the second home screen 210d may be the same as or different from the plurality of menu icons 211 and the like displayed on the home screen 210a.

The menu icons 211 displayed on the second home screen 210d are arranged along the array axis DA. The array axis DA of the plurality of menu icons 211 displayed on the second home screen 210d are parallel or substantially parallel to the Z2-axis. The orthogonal axis VA orthogonal to the array axis DA are parallel or substantially parallel to the X2-axis.

The third sensor arrangement region SA3 is an example of the sensor arrangement region SA. The third sensor arrangement region SA3 is provided on an outer peripheral section of the second touch panel 73b. The touch input keys 74 arranged in the third sensor arrangement region SA3 are provided on the outer peripheral section of the second touch panel 73b.

In the third sensor arrangement region SA3, the home key 74a, the help key 74b, the back key 74c, and the server switching key 74d are arranged as the plurality of touch input keys 74. The home key 74a, the help key 74b, the back key 74c, and the server switching key 74d are arranged in the outer peripheral section of the second touch panel 73b.

The home key 74a in the sixth control panel 70f is arranged at a position in the +Z2 direction of the second touch panel 73b. The home key 74a in the sixth control panel 70f corresponds to an example of the soft key.

The help key 74b in the sixth control panel 70f is arranged at a position in the -Z2 direction of the second touch panel 73b. The help key 74b in the sixth control panel 70f corresponds to an example of the second soft key. The home key 74a, the help key 74b, and the second touch panel 73b are arranged in an order of the home key 74a, the second touch panel 73b, and the help key 74b along the array axis DA.

The back key 74c in the sixth control panel 70f is arranged at a position in the +Z2 direction of the second touch panel 73b. The back key 74c is arranged at a position in the -X2 direction of the home key 74a.

The server switching key 74d in the sixth control panel 70f is arranged at a position in the +Z2 direction of the second touch panel 73b. The server switching key 74d is arranged at a position in the +X2 direction of the home key 74a. The home key 74a, the back key 74c, and the server switching key 74d are arranged in an order of the back key 74c, the home key 74a, and the server switching key 74d along the orthogonal axis VA.

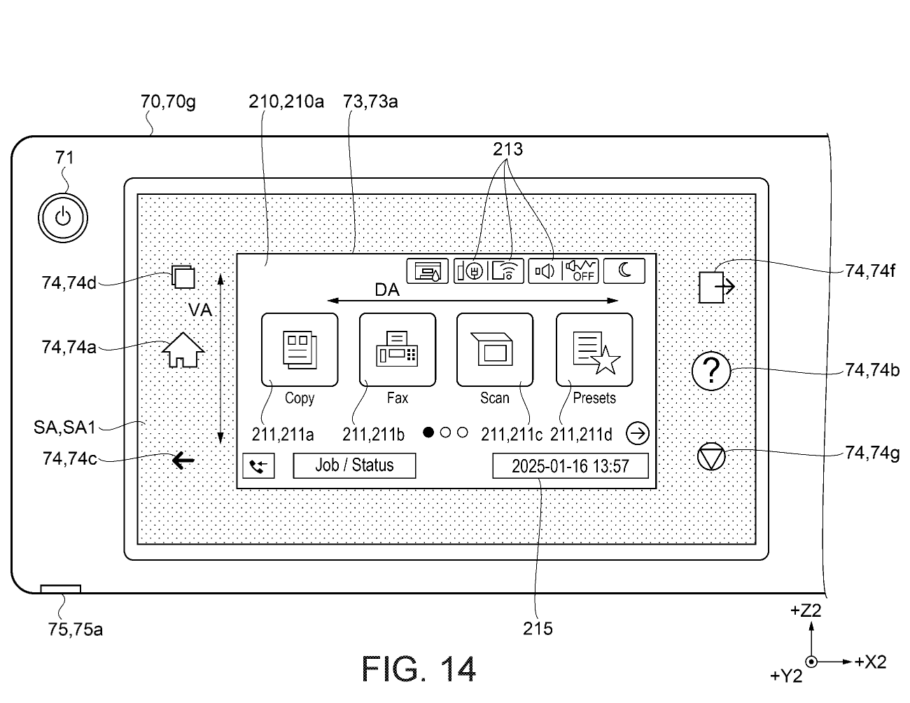

FIG. 14 illustrates a schematic configuration of the control panel 70. FIG. 14 illustrates a schematic configuration of a seventh control panel 70g as an example of the control panel 70. FIG. 14 illustrates an enlarged view of the vicinity of the first touch panel 73a of the seventh control panel 70g. The seventh control panel 70g includes the plurality of input buttons 72 (not illustrated), similarly to the first control panel 70a. FIG. 14 illustrates the first touch panel 73a and the plurality of touch input keys 74 provided on the first sensor arrangement region SA1. The power button 71 may not be included in the seventh control panel 70g.

In the first sensor arrangement region SA1 of the seventh control panel 70g, the home key 74a, the help key 74b, the back key 74c, the server switching key 74d, a logout key 74f, and a cancel key 74g are arranged as the plurality of touch input keys 74. The plurality of touch input keys 74 are arranged on the seventh control panel 70g at a position in the +X2 direction and a position in the -X2 direction of the first touch panel 73a.

The home key 74a of the seventh control panel 70g is arranged at a position in the -X2 direction of the first touch panel 73a. The home key 74a of the seventh control panel 70g corresponds to an example of the soft key.

The help key 74b of the seventh control panel 70g is arranged at a position in the +X2 direction of the first touch panel 73a.

The back key 74c of the seventh control panel 70g is arranged at a position in the - X2 direction of the first touch panel 73a. The back key 74c is arranged at a position in the -Z2 direction of the home key 74a.

The server switching key 74d of the seventh control panel 70g is arranged at a position in the -X2 direction of the first touch panel 73a. The server switching key 74d is arranged at a position in the +Z2 direction of the home key 74a.

The logout key 74f receives touch input by a user. The printer 1 has a user restriction function of restricting users as an example. When the user restriction function is enabled, the user performs an input operation on the logout key 74f. When the user performs the input operation on the logout key 74f, the user logs out of the printer 1.

The logout key 74f of the seventh control panel 70g is arranged at a position in the +X2 direction of the first touch panel 73a. The logout key 74f is arranged at a position in the +Z2 direction of the help key 74b. The logout key 74f of the seventh control panel 70g corresponds to an example of the second soft key. The home key 74a, the logout key 74f, and the first touch panel 73a are arranged in an order of the home key 74a, the first touch panel 73a, and the logout key 74f along the array axis DA.

The cancel key 74g receives touch input by a user. When the user performs an input operation on the cancel key 74g, the printer 1 stops the operation that is being executed. The cancel key 74g of the seventh control panel 70g is arranged at a position in the +X2 direction of the first touch panel 73a. The cancel key 74g is arranged at a position in the -Z2 direction of the logout key 74f and the help key 74b.

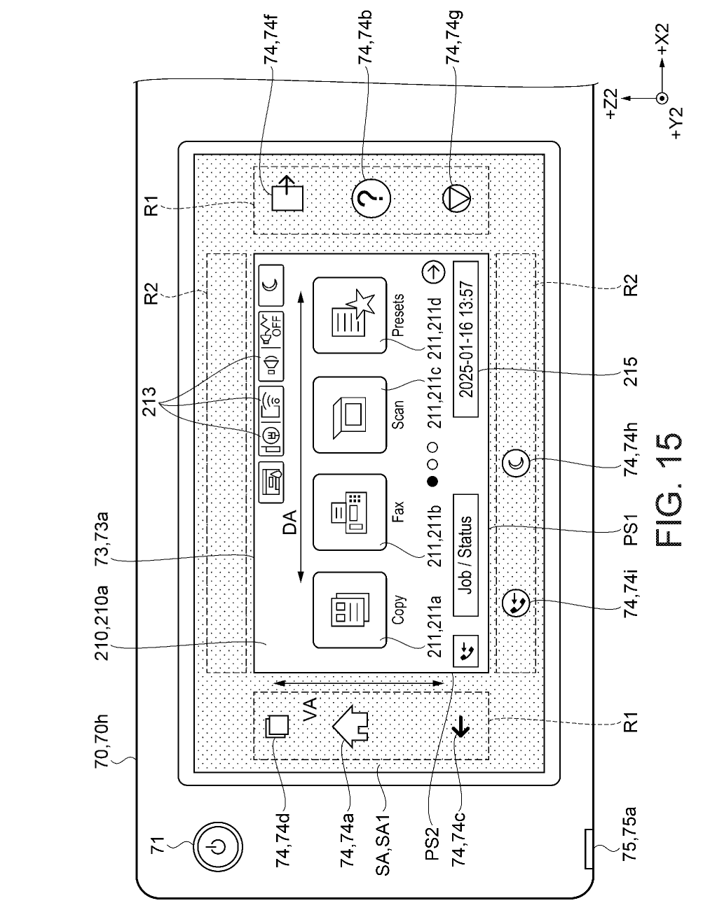

FIG. 15 illustrates a schematic configuration of the control panel 70. FIG. 15 illustrates a schematic configuration of an eighth control panel 70h as an example of the control panel 70. FIG. 15 illustrates an enlarged view of the vicinity of the first touch panel 73a of the eighth control panel 70h. The eighth control panel 70h includes the plurality of input buttons 72 (not illustrated), similarly to the first control panel 70a. FIG. 15 illustrates the first touch panel 73a and the plurality of touch input keys 74 provided on the first sensor arrangement region SA1. The power button 71 may not be included in the eighth control panel 70h.

FIG. 15 illustrates a first arrangement region R1 and a second arrangement region R2 by broken lines in the first sensor arrangement region SA1. The first arrangement region R1 and the second arrangement region R2 are virtual regions that divide the first sensor arrangement region SA1.

The first arrangement region R1 is a region along the second panel side PS2. The first arrangement region R1 is a region in the +X2 direction of the first touch panel 73a and a region in the -X2 direction of the first touch panel 73a. The first arrangement region R1 corresponds to an example of a first region.

The second arrangement region R2 is a region along the first panel side PS1. The second arrangement region R2 is a region in the +Z2 direction of the first touch panel 73a and a region in the -Z2 direction of the first touch panel 73a. The second arrangement region R2 corresponds to an example of a second region.

In the first sensor arrangement region SA1 of the eighth control panel 70h, the home key 74a, the help key 74b, the back key 74c, the server switching key 74d, the logout key 74f, the cancel key 74g, a sleep mode setting key 74h, and a fax notification key 74i are arranged as the plurality of touch input keys 74.

The home key 74a of the eighth control panel 70h is arranged in the first arrangement region R1 in the -X2 direction of the first touch panel 73a. The home key 74a of the eighth control panel 70h corresponds to an example of the soft key.

The help key 74b of the eighth control panel 70h is arranged in the first arrangement region R1 in the +X2 direction of the first touch panel 73a. The help key 74b of the eighth control panel 70h corresponds to an example of the second soft key. The home key 74a, the first touch panel 73a, and the help key 74b are arranged in an order of the home key 74a, the first touch panel 73a, and the help key 74b along the array axis DA.

The back key 74c of the eighth control panel 70h is arranged in the first arrangement region R1 in the -X2 direction of the first touch panel 73a. The back key 74c is arranged at a position in the -Z2 direction of the home key 74a. The back key 74c of the eighth control panel 70h corresponds to an example of the third soft key.

The server switching key 74d of the eighth control panel 70h is arranged in the first arrangement region R1 in the -X2 direction of the first touch panel 73a. The server switching key 74d is arranged at a position in the +Z2 direction of the home key 74a.

The logout key 74f of the eighth control panel 70h is arranged in the first arrangement region R1 in the +X2 direction of the first touch panel 73a. The logout key 74f is arranged at a position in the +Z2 direction of the help key 74b.

The cancel key 74g of the eighth control panel 70h is arranged in the first arrangement region R1 in the +X2 direction of the first touch panel 73a. The cancel key 74g is arranged at a position in the -Z2 direction of the logout key 74f and the help key 74b.

The sleep mode setting key 74h receives touch input by a user. When the user performs an input operation on the sleep mode setting key 74h, the control unit 100 changes the state of the power supply unit 95 to the operable state or the energy saving state.

The sleep mode setting key 74h of the eighth control panel 70h is arranged in the second arrangement region R2 in the -Z2 direction of the first touch panel 73a. The sleep mode setting key 74h of the eighth control panel 70h corresponds to an example of a fourth soft key.

The fax notification key 74i receives touch input by a user. When the user performs an input operation on the fax notification key 74i, the first touch panel 73a displays the fax data information screen.

The fax notification key 74i of the eighth control panel 70h is arranged in the second arrangement region R2 in the -Z2 direction of the first touch panel 73a. The fax notification key 74i is arranged at a position in the -X2 direction of the sleep mode setting key 74h.

In the eighth control panel 70h illustrated in FIG. 15, the touch input keys 74 are not arranged in the second arrangement region R2 in the +Z2 direction of the first touch panel 73a, but the present disclosure is not limited thereto. In the eighth control panel 70h, one or more touch input keys 74 may be arranged in the second arrangement region R2 in the +Z2 direction of the first touch panel 73a.

The eighth control panel 70h includes the sleep mode setting key 74h that receives touch input by a user. The sleep mode setting key 74h is provided on an outer peripheral section of the first touch panel 73a. It is desirable that the home key 74a and the back key 74c are arranged in the first arrangement region R1 along the second panel side PS2, and the sleep mode setting key 74h is arranged in the second arrangement region R2 along the first panel side PS1.

The plurality of touch input keys 74 are arranged in the first arrangement region R1 and the second arrangement region R2, thereby improving the operability of a user.

Among the soft keys, the back key 74c, the logout key 74f, and the server switching key 74d are keys specific to an authentication system of a third party vendor constructed by an open platform. For example, there is an authentication printing system in which only a user specified by IC card authentication or biometric authentication can output a printed material. In the authentication printing system, a PC of a user, a printer, a management server (authentication server) that performs user authentication, and a print data control server that performs management of print data are connected to each other via a network. Software for causing the PC of the user, the management server, and the print data control server to function in cooperation as a system is installed in each of the PC of the user, the management server, and the print data control server. Software is provided by various vendors on their own. When a new printer is to be added to an authentication printing system already built by a third party vendor, the printer's system needs to be customized to fit the system. In the printer, a platform for a user to link the printer to an external system is provided. This is called an open platform.

The printer 1 is equipped with a browser to support applications that can run on the browser. The back key 74c is used when a native screen of the printer 1 transitions to a browser screen. The back key 74c is also used to transition between UI screens in a third party vendor application. The logout key 74f is used when a user logs out of the authentication server. The logout key 74f is also used when transitioning from an authentication server screen to the native screen. The server switching key 74d is used for switching between a plurality of authentication servers (primary server and secondary server) when a plurality of authentication systems are used together.

The summary of the present disclosure is appended below.

### First note

A printing device includes a power switch that receives state change of a power supply and an operation unit that receives an input operation by a user, wherein the operation unit includes a display panel that displays a plurality of touch keys that receive touch input by the user and a soft key that receives the touch input by the user and the soft key is provided on an outer peripheral section of the display panel.

By providing the soft key on the outer peripheral section of the display panel, the operability of a user with respect to the soft key and the display panel is improved.

### Second note

The printing device according to first note, wherein the operation unit includes a second soft key that receives the touch input by the user, the second soft key is provided on the outer peripheral section of the display panel, the display panel displays the plurality of touch keys along a first axis, and the soft key, the second soft key, and the display panel are arranged in an order of the soft key, the display panel, and the second soft key along the first axis.

The soft key and the second soft key are arranged with the display panel interposed therebetween, and thus, the user is prevented from erroneously operating the soft key and the second soft key.

### Third note

The printing device according to second note, wherein the display panel has a rectangular shape having a first side along the first axis and a second side along a second axis orthogonal to the first axis and a first length of the first side is longer than a second length of the second side.

The soft key and the second soft key are arranged along the first side having the first length longer than the second length, and thus, an erroneous operation by the user is further prevented.

### Fourth note

The printing device according to second note or third note, wherein the plurality of touch keys are displayed so as to be configured to move along the first axis.

The user can easily distinguish between the touch key displayed movably and the soft key arranged fixedly. An erroneous operation by the user is prevented.

### Fifth note

The printing device according to any one of second note to fourth note, wherein the operation unit includes a third soft key that receives the touch input by the user and the third soft key is provided on the outer peripheral section of the display panel and is arranged at an arrangement position in a first direction intersecting the first axis with respect to the soft key.

By arranging the third soft key at an arrangement position of the soft key in the first direction, the operability of the user with respect to the soft key and the third soft key is improved.

### Sixth note

The printing device according to fifth note, wherein the operation unit includes a mechanical key that receives the input operation by the user and the soft key, the third soft key, and the mechanical key are arranged in an order of the soft key, the mechanical key, and the third soft key along the second axis.

The soft key and the third soft key are arranged along the second axis with the mechanical key interposed therebetween, and thus the user can easily distinguish the soft key and the third soft key. The operability by the user is improved.

### Seventh note

The printing device according to sixth note, wherein the operation unit includes a fourth soft key that receives the touch input by the user, the fourth soft key is provided on the outer peripheral section of the display panel, the soft key and the third soft key are arranged in a first region along the second side, and the fourth soft key is arranged in a second region along the first side.

The soft key, the second soft key, the third soft key, and the fourth soft key are arranged in the first region and the second region, and thus the operability of the user is improved.

### Eighth note

The printing device according to any one of first note to seventh note, wherein the power switch is mechanical and has an on and off switching function of switching the power supply on and off and, a power-saving switching function of switching a power saving function between activation and stop.

By configuring the power switch mechanically, state change of the power supply can be reliably carried out. The power switch has the power-saving switching function, and thus a configuration of the operation unit is simplified.

### Ninth note

The printing device according to any one of first note to eighth note, wherein the soft key is a capacitance type key.

The soft key is configured as a capacitance type key, and thus, the operability and touch sensitivity of the soft key are improved.

### Tenth note

An operation unit includes a display panel that displays a plurality of touch keys that receive touch input by a user and a soft key that is provided on an outer peripheral section of the display panel and that receives the touch input by a user.

By providing the soft key on the outer peripheral section of the display panel, the operability of a user with respect to the soft key and the display panel is improved.

### Eleventh note

The operation unit according to tenth note further includes a second soft key that receives the touch input by the user, wherein the second soft key is provided on the outer peripheral section of the display panel, the display panel displays the plurality of touch keys along a first axis, and the soft key, the second soft key, and the display panel are arranged in an order of the soft key, the display panel, and the second soft key along the first axis.

The soft key and the second soft key are arranged with the display panel interposed therebetween, and thus, the user is prevented from erroneously operating the soft key and the second soft key.

What is claimed is:

1. A printing device comprising:
a power switch that receives state change of a power supply and
an operation unit that receives an input operation by a user, wherein
the operation unit includes
a display panel that displays a plurality of touch keys that receive touch input by the user and
a soft key that receives the touch input by the user and
the soft key is provided on an outer peripheral section of the display panel.

2. The printing device according to claim 1, wherein
the operation unit includes a second soft key that receives the touch input by the user,
the second soft key is provided on the outer peripheral section of the display panel,
the display panel displays the plurality of touch keys along a first axis, and
the soft key, the second soft key, and the display panel are arranged in an order of the soft key, the display panel, and the second soft key along the first axis.

3. The printing device according to claim 2, wherein
the display panel has a rectangular shape having a first side along the first axis and a second side along a second axis orthogonal to the first axis and
a first length of the first side is longer than a second length of the second side.

4. The printing device according to claim 3, wherein
the plurality of touch keys are displayed so as to be configured to move along the first axis.

5. The printing device according to claim 3, wherein
the operation unit includes a third soft key that receives the touch input by the user and
the third soft key
is provided on the outer peripheral section of the display panel and
is arranged at an arrangement position in a first direction intersecting the first axis with respect to the soft key.

6. The printing device according to claim 5, wherein
the operation unit includes a mechanical key that receives the input operation by the user and
the soft key, the third soft key, and the mechanical key are arranged in an order of the soft key, the mechanical key, and the third soft key along the second axis.

7. The printing device according to claim 6, wherein
the operation unit includes a fourth soft key that receives the touch input by the user,
the fourth soft key is provided on the outer peripheral section of the display panel,
the soft key and the third soft key are arranged in a first region along the second side, and
the fourth soft key is arranged in a second region along the first side.

8. The printing device according to claim 1, wherein
the power switch is mechanical and has an on and off switching function of switching the power supply on and off and, a power-saving switching function of switching a power saving function between activation and stop.

9. The printing device according to claim 1, wherein
the soft key is a capacitance type key.

10. An operation unit comprising:
a display panel that displays a plurality of touch keys that receive touch input by a user and
a soft key that is provided on an outer peripheral section of the display panel and that receives the touch input by a user.

11. The operation unit according to claim 10, further comprising:
a second soft key that receives the touch input by the user, wherein
the second soft key is provided on the outer peripheral section of the display panel,
the display panel displays the plurality of touch keys along a first axis, and
the soft key, the second soft key, and the display panel are arranged in an order of the soft key, the display panel, and the second soft key along the first axis.
